(19) United States
(12) Patent Application Publication
(10) Pub. No.: US 2026/0295521 A1
(43) Pub. Date: Oct. 1, 2026

(54) COMPLETE OXIDATION CATALYSTS FOR DILUTE ALKANES

(71) Applicant: Icarus Technology LLC, Pleasant Hill, CA (US)

(72) Inventors: Guido RADAELLI, Pleasant Hill, CA (US); Luca PINAUDA, Pleasant Hill, CA (US); Erik SCHER, Pleasant Hill, CA (US)

(21) Appl. No.: 19/653,651

(22) Filed: Apr. 21, 2026

Related U.S. Application Data
(62) Division of application No. 18/015,004, filed on Jul. 2, 2021, now abandoned.
(60) Provisional application No. 63/048,400, filed on Jul. 6, 2020.

(51) Int. Cl. B01D 53/86; B01J 23/10; B01J 35/45

(52) U.S. Cl. CPC B01D 53/864; B01J 23/10; B01J 35/45; B01D 2251/102; B01D 2255/2063; B01D 2255/402; B01D 2255/707; B01D 2257/7025; B01D 2258/012; B01D 2258/018

(57) ABSTRACT

Catalysts, catalytic materials, catalytic forms, methods for preparation the same, methods for using the same in catalytic combustion processes, and methods and systems for conducting such combustion processes are provided.

### PRIORITY CLAIM AND CROSS-REFERENCE

This application is a Divisional of U.S. patent application Ser. No. 18/015,004, filed Jan. 6, 2023, which is a U.S. National Phase application of PCT/US2021/040253, filed Jul. 2, 2021, which claims the benefit of U.S. Provisional Patent Application No. 63/048,400, filed Jul. 6, 2020, each of which is incorporated by reference herein in its entirety.

### BACKGROUND

### Technical Field

This disclosure is generally related to catalysts and catalytic processes, and more specifically to high performance and stable catalysts useful as heterogeneous catalysts in catalytic reactions, such as the complete oxidation of diluted methane, ethane, and higher hydrocarbons.

### Description of the Related Art

Methane is considered a greenhouse gas which is 84 times more potent than carbon dioxide in the atmosphere for the first 20 years of its time in the atmosphere. Some of the largest sources of man-made methane emissions include natural gas emissions from the energy industry, including but not limited to: venting from natural gas and oil wells, leaks from pipes and gas processing plants in the upstream and midstream industry, leaks from refineries, downstream chemicals plants, LNG plants, coal mines leaks, coal mine venting, inefficient or incomplete combustion in natural gas engines or mixed feed engines, inefficient combustion at power plants, landfill emissions, agricultural emissions, incomplete combustion in diesel or gasoline engines. The one thing that many of these sources have in common is that the hydrocarbons (including methane) which are emitted into the atmosphere are dilute and therefore difficult to combust completely, leading to hydrocarbon emissions, which although small, can be as impactful to the greenhouse gas emissions profile as the combusted hydrocarbons. For example, if 1% of a methane stream is emitted and 99% combusted to CO₂, then the CO₂ equivalent impact of the 1% methane is almost the same as the 99% which was burned over a 20-year period in the atmosphere.

Mining processes often release hydrocarbons to the atmosphere as a result of either i) ventilation systems used to extract hydrocarbons and other potentially poisonous or dangerous species from the atmosphere inside the mines; or ii) leaks of hydrocarbons naturally contained within the rock strata and seams that are subject to mining. For example, hydrocarbons, particularly methane, trapped in coal seams are released to the atmosphere during mining and post-mining activities due to leaks from the gas extraction pipes or untreated vents of mine shafts ventilation. Conventional catalysts contain very expensive and very easy to poison platinum group metals (PGM) and otherwise have catalytic light-off temperatures that must be operated at temperatures near or above the auto-ignition temperature range of diluted hydrocarbons in air (500-600° C.). Specifically, the PGMs tend to be sensitive to: water/humidity in the gas stream, steam, and poisons, such as sulfur and other metals, that are usually present in the process gas carrying the hydrocarbons to be oxidized. As such an ideal catalyst would be less sensitive to poisons and common atmospheric concentrations to enable their application in a wider range of operating conditions and increase the lifetime of systems containing such catalysts.

Hydrocarbons—usually crude oil and natural gas—are typically extracted from the ground, treated in order to allow their transportation in pipes, further processed into finished products such as pipeline gas or transportation fuels and eventually delivered to the final users via pipelines, ships, railway or trucks. Untreated or processed hydrocarbons are released into the environment at each step of these extraction processes.

For example, associated gas—a mixture of volatile hydrocarbons, usually with a high concentration of methane—may be released from crude oil wells, either untreated or after being combusted with air (flaring), with such combustion allowing for certain uncombusted or combustion by-product hydrocarbons to be released in the atmosphere. Natural gas can be extracted from the ground via extraction and drilling. One common method in certain regions within North America is horizontal fracking. It is estimated that between 1% and 9% of the entire stream of natural gas extracted from fracking is released into the atmosphere via emissions along the series of systems and processes that connect the fracking wells to the final user.

As another example, natural gas extracted from the ground is treated in gas processing plants to separate certain higher hydrocarbons—ethane, propane, butane and natural gasoline—from mainly methane, which is then sold as pipeline gas or sales gas. Gas processing plants emit hydrocarbons into the atmosphere as a result of uncontrolled fugitive emissions—such as leaks from vessels, pipes and valves—and from process vents—such as pipes in direct communication with the atmosphere that are filled with hydrocarbons in certain phases of the plant operation, usually during start-up, shut-down, or emergencies.

Currently it is not technically or economically feasible to oxidize these hydrocarbon streams emitted into the atmosphere due to any combination of these factors: (i) it is technically difficult or economically impractical to generate the operating conditions required for the oxidation with existing materials (for example, the temperature, and/or pressure, and/or methane, alkane, or hydrocarbon concentration of these streams is too low for existing catalysts to oxidize them efficiently); (ii) it is considered unsafe to generate the operating conditions required for the oxidation with existing materials (for example, the stream to be treated would have to be heated above its auto-ignition limit); (iii) the existing materials would not withstand the concentration of poisons and inhibitors usually contained in these hydrocarbon stream (for example, the sulfur compounds contained in these hydrocarbon stream would rapidly de-activate any PGM-based catalyst).

The combustion of hydrocarbons to produce mechanical power, either for transportation or power generation, can be conducted with an amount of oxygen close to the stoichiometric level necessary for the combustion itself—rich burn engines—or with an amount of oxygen larger than what stoichiometrically is required for the combustion process—turbines or lean burn engines. Both of the above systems release hydrocarbons to the atmosphere in different ways, as a result of the different systems utilized for combustion and conversion of the chemical energy into mechanical power.

Lean burn engines are typically utilized for applications that require the production of considerable mechanical power, such as marine transportation, railways or power generation. These engines have either a 4-stroke or a 2-stroke dual fuel design, depending on the specific cycle adopted for the operation of the engine itself. Regardless of the specific cycle, these engines release multiple classes of saturated and unsaturated hydrocarbons into the atmosphere from their exhaust stream as a result of both incomplete combustion and fuel bypass. Incomplete combustion occurs because the operating conditions that are typically achieved in the combustion chamber of these engines do not allow for complete oxidation of all hydrocarbons to CO₂ and water. Fuel bypass can occur because there is an overlap between the phases of the engine cycle, which causes a portion of the fresh hydrocarbon feed to mix with the exhaust stream in the combustion chamber, usually because the fresh stream is injected into the combustion chamber at the same time that the exhaust leaves it.

All industrial processes that utilize hydrocarbons as a feedstock as an input—either as the main feedstock or a utility—typically generate residual streams of fresh or reacted hydrocarbons, usually in the form of offgas, vents or other streams released to the atmosphere. Such streams may contain a variety of hydrocarbons, from fresh hydrocarbons that have not been processed by the industrial equipment—either due to fugitive emissions, incomplete processing, bypass streams or temporary emissions from transient operations—to converted hydrocarbons resulting from the processing of the hydrocarbon feed streams, such as olefins, VOCs and HAPs contained in offgas streams from reactors or exhaust streams from burners or any other combustion equipment.

The quantitative oxidation of VOCs and HAPs is typically required prior to their release into the atmosphere in order to meet the stringent environmental regulations in place almost everywhere. Such oxidation is currently conducted by any of these methods (or combination thereof): (i) High temperature combustion of the streams containing the hydrocarbon by-products in a flare or similar equipment, where additional fuel gas may be added to the original hydrocarbon stream to achieve the combustion temperature required for the quantitative oxidation of VOCs and HAPs; (ii) Lower temperature combustion of these hydrocarbons in catalytic reactors that contain existing catalytic materials—usually based on PGMs—able to oxidize VOCs and HAPs below the levels required by the environmental regulations.

The first method—flaring—is widely utilized across the hydrocarbon value chain, from wellheads to refining and downstream chemical plants. It requires a sufficient amount of fresh hydrocarbons—usually light alkanes such as methane—to be present in the vent stream to achieve the minimum required temperature for self-sustaining combustion and nearly complete oxidation of certain molecular species that cannot be released to the atmosphere above certain concentrations and/or volumes over a period of time. While this method requires inexpensive equipment and no catalytic materials, it sometimes results in large volumes of fuel gas needed for its proper operation and, in general, does not provide any environmental performance beyond the targets strictly required by the existing environmental regulations. For example, it only provides incomplete oxidation of certain hydrocarbon species, usually in the 99% range, thus leaving a certain amount of uncombusted alkanes, olefins, VOCs and HAPs in the exhaust stream released to the atmosphere. This performance is usually sufficient to meet the existing environmental regulations as flaring is typically used for transient streams that result from start-up, shutdown, or emergency operations.

The second method—catalytic oxidation—is generally implemented when the hydrocarbon-containing stream has to be continuously released to the atmosphere and contains molecular species that are particularly toxic or otherwise dangerous for the environment and/or that a simple flare would not be able to properly process. Catalytic oxidation is generally superior to flaring due to its ability to conduct the oxidation process at more favorable operating conditions, usually lower temperatures and lower concentrations of hydrocarbons in the mixture to be oxidized. Thus, it generally requires little to no addition of fuel gas and provides a more complete oxidation of certain hydrocarbon species, such as certain VOCs and HAPs, that are particularly toxic and/or difficult to oxidize. However, the application of catalytic oxidizers is usually hampered by their general sensitivity to poisons (such as sulfur) and inhibitors (such as water or steam), due to the fact that they are typically based on PGM materials. Existing catalytic oxidizers are also unable to completely oxidize certain species, such as methane, whose regulation is currently under discussion in a number of applications, geographies, and industrial sectors.

Therefore there is an industrial need for novel catalytic processes which exhibit one or more of the following properties: (i) more complete oxidation of certain VOCs and HAPs at the same or more favorable operating conditions, such as the same or lower temperatures; (ii) ability to oxidize certain species—such as methane or ethane—that cannot be efficiently treated by the existing materials; (iii) technically and economically viable use of catalytic oxidizers with novel materials for applications where currently flaring is utilized or no solution exists.

Numerous industrial processes release hydrocarbons to the atmosphere as a result of their operations, either continuously or due to transient conditions. These processes can be divided into two general categories: (i) processes where the hydrocarbon stream released into the atmosphere is the result of combustion, generally utilized to generate heat; (ii) processes where the hydrocarbon emissions are the byproducts of chemical processes that convert certain inputs—mostly feed hydrocarbons—into hydrocarbon products.

Examples of the first category can be found in a variety of industrial sectors, from energy to petrochemicals, specialty chemicals, refining, food processing, etc. In all these industries a fuel stream, generally natural gas, is fed to a burner to generate heat, which is then either directly or indirectly transferred to the industrial process. For example, fired heaters are used across the energy, refining and petrochemical sectors to directly provide heat for certain chemical or physical processes or to generate steam that is used as the indirect energy carrier, or gas turbines. Emissions from fired heaters are generally regulated in terms of concentration and cumulative quantity over time of certain species released into the atmosphere. For example, the release of NOₓ species is regulated almost everywhere, and the environmental limits are usually achieved through the use of specific catalytic converters—SCR reactors, which are installed in the flue gas stack of the fired heaters. Depending on the specific fuel utilized by the fired heater, the profile of the hydrocarbon concentrations in the flue gas may require further treatment of the exhaust to meet the environmental thresholds for VOCs and HAPs. In some cases, however, no such treatment is viable with the current catalytic materials due to either the inability of the existing materials to oxidize the exhaust hydrocarbons or their sensitivity to poisons and inhibitors present in the flue gas. Thus, the fuels causing such emission profiles cannot be utilized with the current technology.

Several processes release hydrocarbon streams to the atmosphere as a byproduct of chemical reactions or physical treatments that they apply to their inputs. For example, in the production of polymers—such as polyethylene or polypropylene—it is common to have byproduct or purge streams containing the corresponding monomers—ethylene or propylene—that are sent to flaring prior to being released into the atmosphere. In another example, the production of methanol derivatives—such as formaldehyde—generates tail gas streams containing oxygenates—hydrocarbons that contain oxygen—that need to be completely oxidized prior to their release in the atmosphere. In both the above cases, there is an industry need for advanced catalytic converters based on novel materials to enable the complete oxidation of the hydrocarbons in the off-gas streams at more favorable conditions, such as lower temperatures or without the requirement for additional fuel gas.

In another example, the food processing industry often generates exhaust streams that result from the cooking of certain food ingredients—for example, frying. The use of catalytic converters with novel catalytic processes would enable the complete oxidation of the hydrocarbons in the exhaust stream without the need to utilize expensive PGM-based materials, which are also sensitive to poisons and inhibitors resulting from the industrial process itself.

### BRIEF SUMMARY

In brief, embodiments of the present disclosure are directed to catalysts, catalytic materials, catalytic forms, methods for their preparation, their use in catalytic combustion processes, and methods and systems for conducting such combustion processes commercially. The disclosed catalysts and catalytic materials find utility in various catalytic reactions and combustion applications. In one particular embodiment, the catalysts and catalytic materials are useful for lean hydrocarbon combustion catalysis, such as the complete oxidation of dilute methane streams to CO₂. In another embodiment, the catalysts and catalytic materials are useful for lean hydrocarbon combustion catalysis, such as the complete oxidation of dilute alkane streams to CO₂. In another embodiment, the catalysts and catalytic materials are useful for lean hydrocarbon combustion catalysis, such as the complete oxidation of dilute hydrocarbon streams to CO₂.

In brief, embodiments of the present disclosure are directed to methods of DAO, DMO, and DHO reactions, and catalytic materials and systems to enable and improve said reactions.

In one aspect of the present disclosure, a method for performing dilute methane oxidation (DMO) to convert methane into CO₂ is provided. The method includes mixing a first gas stream comprising methane with a second gas stream comprising oxygen to form a third gas stream comprising methane and oxygen, wherein the third gas stream contains less than 5 mol % methane and performing a DMO reaction by contacting the third gas stream with a DMO catalytic material in a fixed bed reactor to produce a fourth gas stream comprising CO₂ in an amount greater than that present in the third gas stream, wherein the third gas stream enters the fixed bed reactor at a pressure no greater than 5 barg and at a temperature no greater than 600° C. The DMO reaction using the DMO catalytic material as a heterogeneous catalyst has a methane conversion of at least 10% and a selectivity to CO₂ of at least 30% in the fixed bed reactor under the conditions thereof. In some embodiments, the CO₂ selectivity is greater than 50%. In some embodiments, the methane conversion is greater than 30%. In some embodiments, the pressure drop across the fixed bed reactor is at most about 2,500 mBar. In some embodiments, the linear velocity in the fixed bed reactor is at least about 10 m/s. In some embodiments, the GHSV in the fixed bed reactor is at least about 25,000/hr. In some embodiments, the DMO catalytic material maintains a CO₂ selectivity of at least 30% in the fixed bed reactor for at least about 1,000 hours. In some embodiments, the DMO catalytic material maintains a CO₂ selectivity of at least 30% in the fixed bed reactor for at least about 1,000 hours when the third gas stream further comprises steam. In some embodiments, the DMO catalytic material maintains a CO₂ selectivity of at least 30% in the fixed bed reactor for at least about 1,000 hours when the third gas stream further comprises sulfur. In some embodiments, the DMO catalytic material maintains a CO₂ selectivity of at least 30% in the fixed bed reactor for at least about 1,000 hours when the third gas stream further comprises heavy hydrocarbons having at least 6 carbon atoms. In some embodiments, the DMO catalytic material maintains a methane conversion of at least 10% in the fixed bed reactor for at least about 1,000 hours. In some embodiments, the DMO catalytic material maintains a methane conversion of at least 10% in the fixed bed reactor for at least about 1,000 hours when the third gas stream further comprises steam. In some embodiments, the DMO catalytic material maintains a methane conversion of at least 10% in the fixed bed reactor for at least about 1,000 hours when the third gas stream further comprises sulfur. In some embodiments, the DMO catalytic material maintains a methane conversion of at least 10% in the fixed bed reactor for at least about 1,000 hours when the third gas stream further comprises heavy hydrocarbons having at least 6 carbon atoms. In some embodiments, the DMO catalytic material comprises a plurality of nanowires. In some embodiments, the DMO catalytic material comprises a plurality of nanoparticles. In some embodiments, the DMO catalytic material comprises a diluent. In some embodiments, the DMO catalytic material comprises a formed catalytic material. In some embodiments, the DMO catalytic material comprises a binder. In some embodiments, the DMO catalytic material comprises a dopant. In some embodiments, the DMO catalytic material comprises two or more dopants. In some embodiments, the dopant comprises B, Al, Ga, As, P, Sb, Bi, Cu, Co, Fe, Zr, La, Ce, Pr, Nd, Pm, Sm, Eu, Gd, Tb, Dy, Ho, Er, Tb, Yb, or Lu. In some embodiments, the DMO catalytic material comprises two or more dopants. In some embodiments, the two or more dopants are independently B, Al, Ga, As, P, Sb, Bi, Cu, Co, Fe, Zr, La, Ce, Pr, Nd, Pm, Sm, Eu, Gd, Tb, Dy, Ho, Er, Tb, Yb, or Lu. In some embodiments, the DMO catalytic material comprises a coated monolith form. In some embodiments, the DMO catalytic material comprises a perovskite. In some embodiments, the DMO catalytic material comprises a rare earth oxide. In some embodiments, the DMO catalytic material comprises zinc oxide. In some embodiments, the DMO catalytic material comprises a Group 2 oxide. In some embodiments, the DMO catalytic material comprises a mixed metal oxide. In some embodiments, the third gas stream is generated in a 4-stroke or 2-stroke lean burn engine in fluid contact with the fixed bed reactor. In some embodiments, the third gas stream is generated in a rich burn engine in fluid contact with the fixed bed reactor. In some embodiments, the third gas stream is generated in a food processing facility in fluid contact with the fixed bed reactor. In some embodiments, the third gas stream is generated in a coal mine in fluid contact with the fixed bed reactor. In some embodiments, the third gas stream is generated by a ventilation system in a coal mine in fluid contact with the fixed bed reactor. In some embodiments, the third gas stream is generated in a natural gas burning engine in fluid contact with the fixed bed reactor. In some embodiments, the third gas stream is generated in a natural gas burning maritime engine in fluid contact with the fixed bed reactor. In some embodiments, the third gas stream is generated in a liquified natural gas burning engine in fluid contact with the fixed bed reactor. In some embodiments, the third gas stream is generated in a compressed natural gas burning engine in fluid contact with the fixed bed reactor. In some embodiments, the third gas stream is generated in a liquified petroleum gas burning engine in fluid contact with the fixed bed reactor. In some embodiments, the first gas stream is generated in a natural gas compressor in fluid contact with the fixed bed reactor. In some embodiments, the first gas stream further comprises ethane. In some embodiments, the second stream further comprises NO_{X}. In some embodiments the third gas stream is generated in an industrial process using natural gas as feedstock or utility. In some embodiments, one or both of the first gas stream and the third gas stream are generated in an industrial process having natural gas as product, such as, but not limited to, natural gas extraction, processing and transportation. In some embodiments, the fourth gas stream is utilized in an industrial process or an agricultural process using CO₂ as feedstock or utility.

In another aspect of the present disclosure, a method for performing dilute alkane oxidation (DAO) to convert alkanes into CO₂ is provided. The method includes: mixing a first gas stream comprising alkanes with a second gas stream comprising oxygen to form a third gas stream comprising alkanes and oxygen, wherein the third gas stream contains less than 5 mol % alkanes; and performing a DAO reaction by contacting the third gas stream with a heterogeneous DAO catalytic material in a fixed bed reactor to produce a fourth gas stream comprising CO₂ in an amount greater than that present in the third gas stream, wherein the third gas stream enters the fixed bed reactor at a pressure no greater than 5 barg and at a temperature no greater than 600° C. The DAO reaction using the DAO catalytic material as a heterogeneous catalyst has an alkane conversion of at least 10% and a selectivity to CO₂ of at least 30% in the fixed bed reactor under the conditions thereof. In some embodiments, the CO₂ selectivity is greater than 50%. In some embodiments, the alkane conversion is greater than 30%. In some embodiments, the pressure drop across the fixed bed reactor is at most about 2,500 mBar. In some embodiments, the linear velocity in the fixed bed reactor is at least about 10 m/s. In some embodiments, the GHSV in the fixed bed reactor is at least about 25,000/hr. In some embodiments, the DAO catalytic material maintains a CO₂ selectivity of at least 30% in the fixed bed reactor for at least about 1,000 hours. In some embodiments, the DAO catalytic material maintains a CO₂ selectivity of at least 30% in the fixed bed reactor for at least about 1,000 hours when the third gas stream further comprises steam. In some embodiments, the DAO catalytic material maintains a CO₂ selectivity of at least 30% in the fixed bed reactor for at least about 1,000 hours when the third gas stream further comprises sulfur. In some embodiments, the DAO catalytic material maintains a CO₂ selectivity of at least 30% in the fixed bed reactor for at least about 1,000 hours when the third gas stream further comprises heavy hydrocarbons having at least 6 carbon atoms. In some embodiments, the DAO catalytic material maintains an alkane conversion of at least 10% in the fixed bed reactor for at least about 1,000 hours. In some embodiments, the DAO catalytic material maintains an alkane conversion of at least 10% in the fixed bed reactor for at least about 1,000 hours when the third gas stream further comprises steam. In some embodiments, the DAO catalytic material maintains an alkane conversion of at least 10% in the fixed bed reactor for at least about 1,000 hours when the third gas stream further comprises sulfur. In some embodiments, the DAO catalytic material maintains an alkane conversion of at least 10% in the fixed bed reactor for at least about 1,000 hours when the third gas stream further comprises heavy hydrocarbons having at least 6 carbon atoms. In some embodiments, the DAO catalytic material comprises a plurality of nanowires. In some embodiments, the DAO catalytic material comprises a plurality of nanoparticles. In some embodiments, the DAO catalytic material comprises a diluent. In some embodiments, the DAO catalytic material comprises a formed catalytic material. In some embodiments, the DAO catalytic material comprises a binder. In some embodiments, the DAO catalytic material comprises a dopant. In some embodiments, the dopant comprises B, Al, Ga, As, P, Sb, Bi, Cu, Co, Fe, Zr, La, Ce, Pr, Nd, Pm, Sm, Eu, Gd, Tb, Dy, Ho, Er, Tb, Yb, or Lu. In some embodiments, the DAO catalytic material comprises two or more dopants. In some embodiments, the two or more dopants are independently B, Al, Ga, As, P, Sb, Bi, Cu, Co, Fe, Zr, La, Ce, Pr, Nd, Pm, Sm, Eu, Gd, Tb, Dy, Ho, Er, Tb, Yb, or Lu. In some embodiments, the DAO catalytic material comprises a coated monolith form. In some embodiments, the DAO catalytic material comprises a perovskite. In some embodiments, the DAO catalytic material comprises a rare earth oxide. In some embodiments, the DAO catalytic material comprises zinc oxide. In some embodiments, the DAO catalytic material comprises a Group 2 oxide. In some embodiments, the DAO catalytic material comprises a mixed metal oxide. In some embodiments the third gas stream is generated in a 4-stroke or 2-stroke lean burn engine in fluid contact with the fixed bed reactor. In some embodiments, the third gas stream is generated in a rich burn engine in fluid contact with the fixed bed reactor. In some embodiments, the third gas stream is generated in a food processing facility in fluid contact with the fixed bed reactor. In some embodiments, the third gas stream is generated in a coal mine in fluid contact with the fixed bed reactor. In some embodiments, the third gas stream is generated by a ventilation system in a coal mine in fluid contact with the fixed bed reactor. In some embodiments, the third gas stream is generated in a natural gas burning engine in fluid contact with the fixed bed reactor. In some embodiments, the third gas stream is generated in a natural gas burning maritime engine in fluid contact with the fixed bed reactor. In some embodiments, the third gas stream is generated in a liquified natural gas burning engine in fluid contact with the fixed bed reactor. In some embodiments, the third gas stream is generated in a compressed natural gas burning engine in fluid contact with the fixed bed reactor. In some embodiments, the third gas stream is generated in a liquified petroleum gas burning engine in fluid contact with the fixed bed reactor. In some embodiments, the first gas stream is generated in an alkanes gas compressor in fluid contact with the fixed bed reactor. In some embodiments, the first gas stream additionally comprises non-alkane hydrocarbons. In some embodiments, the second stream comprises NO_{X}. In some embodiments, the third gas stream is generated in an industrial process using natural gas as feedstock or utility. In some embodiments, one or both of the first gas stream and the third gas stream are generated in an industrial process having natural gas as product, such as, but not limited to, natural gas extraction, processing and transportation. In some embodiments, the fourth gas stream is utilized in an industrial process or an agricultural process using CO₂ as feedstock or utility.

In still another aspect of the present disclosure, a method for performing dilute hydrocarbon oxidation (DHO) to convert hydrocarbons into CO₂ is provided. The method includes mixing a first gas stream comprising hydrocarbons with a second gas stream comprising oxygen to form a third gas stream comprising hydrocarbons and oxygen, wherein the third gas stream contains less than 5 mol % hydrocarbons; and performing a DHO reaction by contacting the third gas stream with a heterogeneous DHO catalytic material in a fixed bed reactor to produce a fourth gas stream comprising CO₂ in an amount greater than that present in the third gas stream, wherein the third gas stream enters the fixed bed reactor at a pressure no greater than 5 barg and at a temperature no greater than 600° C. The DHO reaction using the DHO catalytic material as a heterogeneous catalyst has a hydrocarbon conversion of at least 10% and a selectivity to CO₂ of at least 30% in the fixed bed reactor under the conditions thereof. In some embodiments, the CO₂ selectivity is greater than 50%. In some embodiments, the hydrocarbon conversion is greater than 30%. In some embodiments, the pressure drop across the fixed bed reactor is at most about 2,500 mBar. In some embodiments, the linear velocity in the fixed bed reactor is at least about 10 m/s. In some embodiments, the GHSV in the reactor is at least about 25,000/hr. In some embodiments, the DHO catalytic material maintains a CO₂ selectivity of at least 30% in the fixed bed reactor for at least about 1,000 hours. In some embodiments, the DHO catalytic material maintains a CO₂ selectivity of at least 30% in the fixed bed reactor for at least about 1,000 hours when the third gas stream further comprises steam. In some embodiments, the DHO catalytic material maintains a CO₂ selectivity of at least 30% in the fixed bed reactor for at least about 1,000 hours when the third gas stream further comprises sulfur. In some embodiments, the DHO catalytic material maintains a CO₂ selectivity of at least 30% in the fixed bed reactor for at least about 1,000 hours when the third gas stream further comprises heavy hydrocarbons with at least 6 carbon atoms. In some embodiments, the DMO catalytic material maintains a hydrocarbon conversion of at least 10% in the fixed bed reactor for at least about 1,000 hours. In some embodiments, the DMO catalytic material maintains a hydrocarbon conversion of at least 10% in the fixed bed reactor for at least about 1,000 hours when the third gas stream further comprises steam. In some embodiments, the DMO catalytic material maintains a hydrocarbon conversion of at least 10% in the fixed bed reactor for at least about 1,000 hours when the third gas stream further comprises sulfur. In some embodiments, the DMO catalytic material maintains a hydrocarbon conversion of at least 10% in the fixed bed reactor for at least about 1,000 hours when the third gas stream further comprises heavy hydrocarbons with at least 6 carbon atoms. In some embodiments, the DHO catalytic material comprises a plurality of nanowires. In some embodiments, the DHO catalytic material comprises a plurality of nanoparticles. In some embodiments, the DHO catalytic material comprises a diluent. In some embodiments, the DHO catalytic material comprises a formed catalytic material. In some embodiments, the DHO catalytic material comprises a binder. In some embodiments, the DHO catalytic material comprises a dopant. In some embodiments, the dopant comprises B, Al, Ga, As, P, Sb, Bi, Cu, Co, Fe, Zr, La, Ce, Pr, Nd, Pm, Sm, Eu, Gd, Tb, Dy, Ho, Er, Tb, Yb, or Lu. In some embodiments, the DHO catalytic material comprises two or more dopants. In some embodiments, the two or more dopants are independently B, Al, Ga, As, P, Sb, Bi, Cu, Co, Fe, Zr, La, Ce, Pr, Nd, Pm, Sm, Eu, Gd, Tb, Dy, Ho, Er, Tb, Yb, or Lu. In some embodiments, the DHO catalytic material comprises a coated monolith form. In some embodiments, the DHO catalytic material comprises a perovskite. In some embodiments, the DHO catalytic material comprises a rare earth oxide. In some embodiments, the DHO catalytic material comprises zinc oxide. In some embodiments, the DHO catalytic material comprises a Group 2 oxide. In some embodiments, the DHO catalytic material comprises a mixed metal oxide. In some embodiments, the third gas stream is generated in a 4-stroke or 2-stroke lean burn engine in fluid contact with the fixed bed reactor. In some embodiments, the third gas stream is generated in a rich burn engine in fluid contact with the fixed bed reactor. In some embodiments, the third gas stream is generated in a food processing facility in fluid contact with the fixed bed reactor. In some embodiments, the third gas stream is generated in a coal mine in fluid contact with the fixed bed reactor. In some embodiments, the third gas stream is generated by a ventilation system in a coal mine in fluid contact with the fixed bed reactor. In some embodiments, the third gas stream is generated in a natural gas burning engine in fluid contact with the fixed bed reactor. In some embodiments, the third gas stream is generated in a natural gas burning maritime engine in fluid contact with the fixed bed reactor. In some embodiments, the third gas stream is generated in a liquified natural gas burning engine in fluid contact with the fixed bed reactor. In some embodiments, the third gas stream is generated in a compressed natural gas burning engine in fluid contact with the fixed bed reactor. In some embodiments, the third gas stream is generated in a liquified petroleum gas burning engine in fluid contact with the fixed bed reactor. In some embodiments, the first gas stream is generated in a hydrocarbon compressor in fluid contact with the fixed bed reactor. In some embodiments, the second stream further comprises NO_{X}. In some embodiments, the third gas stream is generated in an industrial process using natural gas as feedstock or utility. In some embodiments, one or both of the first gas stream and the third gas stream are generated in an industrial process having natural gas as product, such as, but not limited to, natural gas extraction, processing and transportation. In some embodiments, the fourth gas stream is utilized in an industrial process and an agricultural process using CO₂ as feedstock or utility.

In still another aspect of the present disclosure, a DHO catalytic material comprising a perovskite is provided. The DHO catalytic material further comprises one or more dopants from group 2 and at least one dopant from groups 4, 9, 10, 11 or combinations thereof, wherein the DHO catalytic material comprises a hydrocarbon conversion of at least 10% and a selectivity to CO₂ of at least 30% when the DHO catalytic material is employed as a heterogeneous catalyst contacting a gas stream comprising oxygen and a hydrocarbon in a fixed bed reactor at a pressure no greater than 5 barg and at a temperature no greater than 600 ° C., wherein the gas stream contains less than 5 mol % hydrocarbons.

In still another aspect of the present disclosure, a DHO catalytic material comprising a mixed lanthanide oxide is provided. The DHO catalytic material further comprises one or more dopants from group 2 and at least one dopant from groups 4, 9, 10, 11 or combinations thereof, wherein the DHO catalytic material comprises a hydrocarbon conversion of at least 10% and a selectivity to CO₂ of at least 30% when the DHO catalytic material is employed as a heterogeneous catalyst contacting a gas stream comprising oxygen and a hydrocarbon in a fixed bed reactor at a pressure no greater than 5 barg and at a temperature no greater than 600° C., wherein the gas stream contains less than 5 mol % hydrocarbons.

In still another aspect of the present disclosure, a DHO catalytic material comprising a plurality of nanowires is provided. The DHO catalytic material further comprises one or more dopants from group 2 and at least one dopant from groups 4, 9, 10, 11 or combinations thereof, wherein the DHO catalytic material comprises a hydrocarbon conversion of at least 10% and a selectivity to CO₂ of at least 30% when the DHO catalytic material is employed as a heterogeneous catalyst contacting a gas stream comprising oxygen and a hydrocarbon in a fixed bed reactor at a pressure no greater than 5 barg and at a temperature no greater than 600° C., wherein the gas stream contains less than 5 mol % hydrocarbons.

In still another aspect of the present disclosure, a DHO catalytic material comprising a plurality of nanoparticles is provided. The DHO catalytic material further comprises one or more dopants from group 2 and at least one dopant from groups 4, 9, 10, 11 or combinations thereof, wherein the DHO catalytic material comprises a hydrocarbon conversion of at least 10% and a selectivity to CO₂ of at least 30% when the DHO catalytic material is employed as a heterogeneous catalyst contacting a gas stream comprising oxygen and a hydrocarbon in a fixed bed reactor at a pressure no greater than 5 barg and at a temperature no greater than 600° C., wherein the gas stream contains less than 5 mol % hydrocarbons.

In still another aspect of the present disclosure, a DAO catalytic material comprising a perovskite is provided. The DAO catalytic material further comprises one or more dopants from group 2 and at least one dopant from groups 4, 9, 10, 11 or combinations thereof, wherein the DAO catalytic material comprises an alkane conversion of at least 10% and a selectivity to CO₂ of at least 30% when the DAO catalytic material is employed as a heterogeneous catalyst contacting a gas stream comprising oxygen and an alkane in a fixed bed reactor at a pressure no greater than 5 barg and at a temperature no greater than 600° C., wherein the gas stream contains less than 5 mol % alkanes.

In still another aspect of the present disclosure, a DAO catalytic material comprising a mixed lanthanide oxide is provided. The DAO catalytic material further comprises one or more dopants from group 2 and at least one dopant from groups 4, 9, 10, 11 or combinations thereof, wherein the DAO catalytic material comprises an alkane conversion of at least 10% and a selectivity to CO₂ of at least 30% when the DAO catalytic material is employed as a heterogeneous catalyst contacting a gas stream comprising oxygen and an alkane in a fixed bed reactor at a pressure no greater than 5 barg and at a temperature no greater than 600° C., wherein the gas stream contains less than 5 mol % alkanes.

In still another aspect of the present disclosure, a DAO catalytic material comprising a plurality of nanowires is provided. The DAO catalytic material further comprises one or more dopants from group 2 and at least one dopant from groups 4, 9, 10, 11 or combinations thereof, wherein the DAO catalytic material comprises an alkane conversion of at least 10% and a selectivity to CO₂ of at least 30% when the DAO catalytic material is employed as a heterogeneous catalyst contacting a gas stream comprising oxygen and an alkane in a fixed bed reactor at a pressure no greater than 5 barg and at a temperature no greater than 600° C., wherein the gas stream contains less than 5 mol % alkanes.

In still another aspect of the present disclosure, a DAO catalytic material comprising a plurality of nanoparticles is provided. The DAO catalytic material further comprises one or more dopants from group 2 and at least one dopant from groups 4, 9, 10, 11 or combinations thereof, wherein the DAO catalytic material comprises an alkane conversion of at least 10% and a selectivity to CO₂ of at least 30% when the DAO catalytic material is employed as a heterogeneous catalyst contacting a gas stream comprising oxygen and an alkane in a fixed bed reactor at a pressure no greater than 5 barg and at a temperature no greater than 600° C., wherein the gas stream contains less than 5 mol % alkanes.

In still another aspect of the present disclosure, a DMO catalytic material comprising a perovskite is provided. The DMO catalytic material further comprises one or more dopants from group 2 and at least one dopant from groups 4, 9, 10, 11 or combinations thereof, wherein the DMO catalytic material comprises a methane conversion of at least 10% and a selectivity to CO₂ of at least 30% when the DMO catalytic material is employed as a heterogeneous catalyst contacting a gas stream comprising oxygen and methane in a fixed bed reactor at a pressure no greater than 5 barg and at a temperature no greater than 600° C., wherein the gas stream contains less than 5 mol % methane.

In still another aspect of the present disclosure, a DMO catalytic material comprising a mixed lanthanide oxide is provided. The DMO catalytic material further comprises one or more dopants from group 2 and at least one dopant from groups 4, 9, 10, 11 or combinations thereof, wherein the DMO catalytic material comprises a methane conversion of at least 10% and a selectivity to CO₂ of at least 30% when the DMO catalytic material is employed as a heterogeneous catalyst contacting a gas stream comprising oxygen and methane in a fixed bed reactor at a pressure no greater than 5 barg and at a temperature no greater than 600° C., wherein the gas stream contains less than 5 mol % methane.

In still another aspect of the present disclosure, a DMO catalytic material comprising a plurality of nanowires is provided. The DMO catalytic material further comprises one or more dopants from group 2 and at least one dopant from groups 4, 9, 10, 11 or combinations thereof, wherein the DMO catalytic material comprises a methane conversion of at least 10% and a selectivity to CO₂ of at least 30% when the DMO catalytic material is employed as a heterogeneous catalyst contacting a gas stream comprising oxygen and methane in a fixed bed reactor at a pressure no greater than 5 barg and at a temperature no greater than 600° C., wherein the gas stream contains less than 5 mol % methane.

In still another aspect of the present disclosure, a DMO catalytic material comprising a plurality of nanoparticles is provided. The DMO catalytic material further comprises one or more dopants from group 2 and at least one dopant from groups 4, 9, 10, 11 or combinations thereof, wherein the DMO catalytic material comprises a methane conversion of at least 10% and a selectivity to CO₂ of at least 30% when the DMO catalytic material is employed as a heterogeneous catalyst contacting a gas stream comprising oxygen and methane in a fixed bed reactor at a pressure no greater than 5 barg and at a temperature no greater than 600° C., wherein the gas stream contains less than 5 mol % methane.

### BRIEF DESCRIPTION OF THE DRAWINGS

In the drawings, the sizes and relative positions of elements in the drawings are not necessarily drawn to scale. For example, the various elements and angles are not drawn to scale, and some of these elements are arbitrarily enlarged and positioned to improve drawing legibility. Further, the particular shapes of the elements as drawn are not intended to convey any information regarding the actual shape of the particular elements, and have been selected solely for ease of recognition in the drawings.

FIG. 1 shows a system for conducting the DMO, DAO, or DHO reaction on a vent gas stream, in accordance with some embodiments.

FIG. 2 shows a system for conducting the DMO, DAO, or DHO reaction on a vent gas stream, in accordance with some embodiments.

FIG. 3 shows a system for conducting the DMO, DAO, or DHO reaction on a vent gas stream, in accordance with some embodiments.

FIG. 4 shows a modified natural gas system for comprising a DMO, DAO, or DHO reactor for reacting with uncombusted methane, alkanes, or hydrocarbons, in accordance with some embodiments.

FIG. 5 shows a modified engine system for comprising a DMO, DAO, or DHO reactor for reacting with uncombusted methane, alkanes, or hydrocarbons, in accordance with some embodiments.

FIG. 6 shows a modified engine for comprising a DMO, DAO, or DHO reactor for reacting with uncombusted methane, alkanes, or hydrocarbons, in accordance with some embodiments.

FIG. 7 shows a modified engine for comprising a DMO, DAO, or DHO reactor for reacting with uncombusted methane, alkanes, or hydrocarbons, in accordance with some embodiments.

FIG. 8 shows a modified engine for comprising a DMO, DAO, or DHO reactor for reacting with uncombusted methane, alkanes, or hydrocarbons, in accordance with some embodiments.

### DETAILED DESCRIPTION

In the following description, certain specific details are set forth in order to provide a thorough understanding of various embodiments. However, one skilled in the art will understand that the invention may be practiced without these details. In other instances, well-known structures have not been shown or described in detail to avoid unnecessarily obscuring descriptions of the embodiments. Unless the context requires otherwise, throughout the specification and claims which follow, the word “comprise” and variations thereof, such as, “comprises” and “comprising” are to be construed in an open, inclusive sense, that is, as “including, but not limited to.” Further, headings provided herein are for convenience only and do not interpret the scope or meaning of the claimed invention.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. Also, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise. Further, as used in this specification and the appended claim, the term “about” has the meaning reasonably ascribed to it by a person of ordinary skill in the art when used in conjunction with a stated numerical value or range, i.e., denoting somewhat more or somewhat less than the stated value or range, to within a range of ±20% of the stated value; ±19% of the stated value; ±18% of the stated value; ±17% of the stated value; ±16% of the stated value; ±15% of the stated value; ±14% of the stated value; ±13% of the stated value; ±12% of the stated value; ±11% of the stated value; ±10% of the stated value; ±9% of the stated value; ±8% of the stated value; ±7% of the stated value; ±6% of the stated value; ±5% of the stated value; ±4% of the stated value; ±3% of the stated value; ±2% of the stated value; or ±1% of the stated value.

### Definitions

As used herein, and unless the context dictates otherwise, the following terms have the meanings as specified below.

“Catalyst” means a substance that alters the rate of a chemical reaction. A catalyst may increase the chemical reaction rate. Catalysts participate in a reaction such that they are not fundamentally consumed during the course of a reaction. “Catalytic” means having the properties of a catalyst.

“Catalytic material” refers to a plurality of catalyst particles, which may optionally be combined with a support, diluent and/or binder.

“Catalyst form” or “catalytic form” refers to the physical shape of a catalytic material. For example, catalyst forms include catalysts and/or catalytic materials extruded or pelleted into various shapes, or deposited upon various support structures, including honeycomb structures, grids, monoliths, metal foils, fiberglass sheets, inorganic foams, and the like, as discussed in more detail below.

“Catalyst formulation” or “catalytic formulation” refers to the chemical composition of a catalytic material. For example, a catalyst formulation may include a catalyst and one or more support, diluent and/or binder materials.

An “extrudate” refers to a material (e.g., catalytic material) prepared by forcing a semisolid material comprising a catalyst through a die or opening of appropriate shape. Extrudates can be prepared in a variety of shapes and structures by common means known in the art.

A “formed aggregate” or “formed catalytic material” refers to an aggregation of catalytic material particles, either alone or in conjunction with one or more other materials, e.g., catalytic materials, dopants, diluents, support materials, binders, etc. formed into a single particle. Formed aggregates include, without limitation, extruded particles, termed “extrudates”, pressed or cast particles, e.g., pellets such as tablets, ovals, spherical particles, etc., coated particles, e.g., spray, immersion or pan coated particles, pan agglomerated particles, impregnated particles, e.g., monoliths, foils, foams, honeycombs, or the like. Formed aggregates may range in size from particles having individual cross sections in the micron range to cross sections in the millimeter range, to even larger particles such as monolithic formed aggregates, that may be on the order of centimeters or even meters in cross section.

A “pellet”, “pressed pellet”, “tablet” or “tableted” refers to a material (e.g., catalytic material) prepared by applying pressure to (i.e., compressing) a material comprising a catalyst into a desired shape. Pellets having various dimensions and shapes can be prepared according to common techniques in the art.

“Monolith” or “monolith support” is generally a structure formed from a single structural unit preferably having passages disposed through it in either an irregular or regular pattern with porous or non-porous walls separating adjacent passages. Examples of such monolithic supports include, e.g., ceramic or metal foam-like or porous structures. The single structural unit may be used in place of or in addition to conventional particulate or granular catalysts (e.g., pellets or extrudates). Monoliths generally have a porous fraction ranging from about 60% to 90+% and a flow resistance substantially less than the flow resistance of a packed bed of similar volume (e.g., less than 10% to less than 30% of the flow resistance of a packed bed of similar volume). Examples of regular patterned substrates include monolith honeycomb supports used for purifying exhausts from motor vehicles and used in various chemical processes and ceramic foam structures having irregular passages. Many types of monolith support structures made from conventional refractory or ceramic materials such as alumina, cordierite, zirconia, yttrium, silicon carbide, and mixtures thereof, are well known and commercially available. Monoliths include, but are not limited to, foams, honeycombs, foils, mesh, gauze and the like.

“Bulk catalyst” or “bulk material” refers to a catalyst without nanosized dimensions. For example, bulk catalysts and materials generally have dimensions of 100 nanometers or more. Such materials can be prepared, for example, by traditional techniques, for example by milling or grinding large catalyst particles to obtain smaller/higher surface area catalyst particles.

“Nanostructured catalyst” means a catalyst having at least one dimension on the order of nanometers (e.g., between about 1 and 100 nanometers). Non-limiting examples of nanostructured catalysts include nanoparticle catalysts and nanowire catalysts.

“Nanoparticle” means a particle having at least one diameter on the order of nanometers (e.g., between about 1 and 100 nanometers).

“Nanowire” means a nanowire structure having at least one dimension on the order of nanometers (e.g., between about 1 and 100 nanometers) and an aspect ratio greater than 10:1. The “aspect ratio” of a nanowire is the ratio of the actual length (L) of the nanowire to the diameter (D) of the nanowire. Aspect ratio is expressed as L:D. Exemplary nanowires are known in the art.

“Polycrystalline nanowire” means a nanowire having multiple crystal domains. Polycrystalline nanowires often have different morphologies (e.g., bent vs. straight) as compared to the corresponding “single-crystalline” nanowires.

“Length” of a nanowire means the shortest distance between the two distal ends of a nanowire as measured by transmission electron microscopy (TEM) in bright field mode at 5 keV. “Average length” refers to the average of the effective lengths of individual nanowires within a plurality of nanowires.

The “diameter” of a nanowire is measured in an axis perpendicular to the axis of the nanowire's actual length. The diameter of a nanowire can vary from narrow to wide as measured at different points along the nanowire length. As used herein, the diameter of a nanowire is the most prevalent (i.e., the mode) diameter.

“Inorganic” means a substance comprising a metal or semi-metal element. In certain embodiments, inorganic refers to a substance comprising a metal element. An inorganic compound can contain one or more metals in their elemental state, or more typically, a compound formed by a metal ion (Mⁿ⁺, wherein n 1, 2, 3, 4, 5, 6 or 7) and an anion (X^{m-}, m is 1, 2, 3 or 4), which balance and neutralize the positive charges of the metal ion through electrostatic interactions. Non-limiting examples of inorganic compounds include oxides, hydroxides, halides, nitrates, sulfates, carbonates, phosphates, acetates, oxalates, and combinations thereof, of metal elements. Other non-limiting examples of inorganic compounds include Na₂CO₃, Na₂PO₄, NaOH, Na₂O, NaCl, NaBr, NaI, Na₂C₂O₄, Na₂SO₄, K₂CO₃,K₂PO₄, KOH, K₂O, KCl, KBr, KI, K₂C₂O₄, K₂SO₄, Cs₂CO₃, CsPO₄, CsOH, Cs₂O, CsCl, CsBr, CsI, CsC₂O₄, CsSO₄, CuO, Cu(OH)₂, CuCO₃, CuCl₂, CuSO₄, Cu(NO₃)₂, Be(OH)₂, BeCO₃, BePO₄, BeO, BeCl₂, BeBr₂, BeI₂, BeC₂O₄. BeSO₄, Mg(OH)₂, MgCO₃, MgPO₄, MgO, MgCl₂, MgBr₂, MgI₂, MgC₂O₄. MgSO₄, Ca(OH)₂, CaO, CaCO₃, CaPO₄, CaCl₂, CaBr₂, CaI₂, Ca(OH)₂, CaC₂O₄, CaSO₄, Y₂O₃, Y₂(CO₃)₃, Y₂(PO₄)₃, Y(OH)₃, YCl₃, YBr₃, YI₃, Y₂(C₂O4)₃, Y₂(SO4)₃, ZnO, Zn(OH)₂, ZnCO₃, ZnCl₂, ZnSO₄, Zn(NO₃)₂, Zr(OH)₄, Zr(CO₃)₂, Zr(PO₄)₂, ZrO(OH)₂, ZrO2, ZrCl₄, ZrBr₄, ZrI₄, Zr(C₂O₄)₂, Zr(SO₄)₂, Ti(OH)₄, TiO(OH)₂, Ti(CO₃)₂, Ti(PO₄)₂, TiO2, TiCl₄, TiBr₄, TiI₄, Ti(C₂O₄)₂, Ti(SO₄)₂,BaO, Ba(OH)₂, BaCO₃, BaPO₄, BaCl₂, BaBr₂, BaI₂, BaC₂O₄, BaSO₄, La(OH)₃, La₂(CO₃)₃, La₂(PO₄)₃, La₂O₃, LaCl₃, LaBr₃, LaI₃, La₂(C₂O₄)₃, La₂(SO₄)₃, Ce(OH)₄, Ce(CO₃)₂, Ce(PO₄)₂, CeO₂, Ce₂O₃, CeCl₄, CeBr₄, CeI₄, Ce(C₂O₄)₂, Ce(SO₄)₂, ThO₂, Th(CO₃)₂, Th(PO₄)₂, ThCl₄, ThBr₄, ThI₄, Th(OH)₄, Th(C₂O₄)₂, Th(SO₄)₂, Sr(OH)₂, SrCO₃, SrPO₄, SrO, SrCl₂, SrBr₂, SrI₂, SrC₂O₄, SrSO₄, Sm₂O₃, Sm₂(CO₃)₃, Sm₂(PO₄)₃, SmCl₃, SmBr₃, SmI₃, Sm(OH)₃, Sm₂(CO3)₃, Sm₂(C₂O₃)₃, Sm₂(SO₄)₃, SrCoO₃, molybdenum oxides, molybdenum hydroxides, molybdenum carbonates, molybdenum phosphates, molybdenum chlorides, molybdenum bromides, molybdenum iodides, molybdenum oxalates, molybdenum sulfates, manganese oxides, manganese chlorides, manganese bromides, manganese iodides, manganese hydroxides, manganese oxalates, manganese sulfates, manganese tungstates, vanadium oxides, vanadium carbonates, vanadium phosphates, vanadium chlorides, vanadium bromides, vanadium iodides, vanadium hydroxides, vanadium oxalates, vanadium sulfates, tungsten oxides, tungsten carbonates, tungsten phosphates, tungsten chlorides, tungsten bromides, tungsten iodides, tungsten hydroxides, tungsten oxalates, tungsten sulfates, neodymium oxides, neodymium carbonates, neodymium phosphates, neodymium chlorides, neodymium bromides, neodymium iodides, neodymium hydroxides, neodymium oxalates, neodymium sulfates, europium oxides, europium carbonates, europium phosphates, europium chlorides, europium bromides, europium iodides, europium hydroxides, europium oxalates, europium sulfates rhenium oxides, rhenium carbonates, rhenium phosphates, rhenium chlorides, rhenium bromides, rhenium iodides, rhenium hydroxides, rhenium oxalates, rhenium sulfates, chromium oxides, chromium carbonates, chromium phosphates, chromium chlorides, chromium bromides, chromium iodides, chromium hydroxides, chromium oxalates, chromium sulfates, potassium molybdenum oxides, perovskites and the like.

“Oxide” refers to a metal compound comprising oxygen. Examples of oxides include, but are not limited to, metal oxides (MₓO_{y}), metal oxyhalides (MₓO_{y}X_{z}), metal oxynitrates (MₓO_{y}(NO₃)_{z}), metal phosphates (Mₓ(PO₄)_{y}), metal oxycarbonates (MₓO_{y}(CO₃)_{z}), metal carbonates, metal oxyhydroxides (MₓO_{y}(OH)_{z}), metal hydroxides (Mₓ(OH)_{z}) and the like, wherein X is independently, at each occurrence, fluoro, chloro, bromo or iodo, and x, y and z are numbers from 1 to 100.

“Crystal domain” means a continuous region over which a substance is crystalline.

“Single-crystalline nanowires” means a nanowire having a single crystal domain.

“Single-crystalline nanoparticles” means a nanoparticle having a single crystal domain.

“Active” or “catalytically active” refers to a catalyst which has substantial activity in the reaction of interest. For example, in some embodiments a catalyst which is dilute methane oxidation or combustion active (i.e., has activity in the complete combustion of methane reaction) has a CO₂ selectivity of 15% or more and/or a methane conversion of 10% or more when the catalyst is employed as a heterogeneous catalyst in the DHO, DAO, or DMO reactions at a temperature of 600° C. or less, for example 550° C. or less, 500° C. or less, 450° C. or less, 400° C. or less or 350° C. or less.

“Inactive” or “catalytically inactive” refers to a catalyst which does not have substantial activity in the reaction of interest. For example, in some embodiments a catalyst which is dilute methane oxidation or combustion inactive has a CO₂ selectivity of less than 15% and/or a methane conversion of less than 10% when the catalyst is employed as a heterogeneous catalyst in the DHO, DAO, or DMO reactions at a temperature of 600° C. or less, for example 550° C. or less, 500° C. or less, 450° C. or less, 400° C. or less or 350° C. or less.

“Methane conversion” is the percent of methane in the feed gas which is consumed during the reaction.

“Activation temperature” refers to the temperature at which a catalyst becomes catalytically active.

“Light off temperature” is the temperature at which a catalyst or catalytic material has sufficient catalytic activity to initiate the desired reaction. In certain embodiments, e.g., for exothermic reactions like combustion, the light off temperature is at a sufficient level to not only allow initiation of the catalyzed reaction, but to do so at a rate that is thermally self-sufficient, e.g., generating enough thermal energy to maintain the reaction temperature at or above the initiation temperature.

“Methane combustion activity”, “Alkane combustion activity”, “Hydrocarbon combustion activity” refers to the ability of a catalyst to catalyze the methane, alkane, or hydrocarbon combustion reactions respectively.

A catalyst having “high methane combustion performance”, “high alkane combustion performance”, or “high hydrocarbon combustion performance” refers to a catalyst having a CO₂ selectivity of 50% or more and a methane, or alkane, or hydrocarbon conversion respectively conversion of 50% or more when the catalyst is employed as a heterogeneous catalyst in the DHO, DAO, or DMO reactions at a specific temperature, for example 450° C. or less.

A catalyst having “moderate methane combustion performance”, “moderate alkane combustion performance”, or “moderate hydrocarbon combustion performance” refers to a catalyst having a CO₂ selectivity of about 25-50% and a methane, or alkane, or hydrocarbon conversion respectively of about 25-50% when the catalyst is employed as a heterogeneous catalyst in the DHO, DAO, or DMO reactions at a temperature of 450° C. or less.

A catalyst having “low methane combustion performance”, “moderate alkane combustion performance”, or “moderate hydrocarbon combustion performance” refers to a catalyst having a CO₂ selectivity of about 15-25% and a methane, or alkane, or hydrocarbon conversion respectively of about 10-25% when the catalyst is employed as a heterogeneous catalyst in the DHO, DAO, or DMO reactions at a temperature of 450° C. or less.

“Base material” refers to the major catalytically active component of a catalyst. For example a rare earth oxide which is doped with a dopant comprises a rare earth oxide base material.

“Dopant,” “doping agent” or “doping element” is additive added to or incorporated within a catalyst to optimize catalytic performance (e.g. increase or decrease catalytic activity). As compared to the undoped catalyst, a doped catalyst may increase or decrease the selectivity, conversion, and/or yield of a reaction catalyzed by the catalyst. A dopant may be present in the base catalyst in any amount, and may in some embodiments be present in 50% or less by weight relative to the base catalyst or in other embodiments it is present in more than 50% by weight relative to the base catalyst.

“Atomic percent” (at % or at/at) or “atomic ratio” when used in the context of nanowire dopants refers to the ratio of the total number of dopant atoms to the total number of metal atoms in the nanowire. For example, the atomic percent of dopant in a lithium doped Mg₆MnO₈ nanowire is determined by calculating the total number of lithium atoms and dividing by the sum of the total number of magnesium and manganese atoms and multiplying by 100 (i.e., atomic percent of dopant=[Li atoms/(Mg atoms+Mn atoms)]×100).

“Weight percent” (wt/wt)” when used in the context of nanowire dopants refers to the ratio of the total weight of dopant to the total combined weight of the dopant and the nanowire. For example, the weight percent of dopant in a lithium doped Mg₆MnO₈ nanowire is determined by calculating the total weight of lithium and dividing by the sum of the total combined weight of lithium and Mg₆MnO₈ and multiplying by 100 (i.e., weight percent of dopant=[Li weight/(Li weight+Mg₆MnO₈ weight)]×100).

As used herein, “effective diameter” is calculated as 6*(volume)/(surface area).

“Group 1” elements include lithium (Li), sodium (Na), potassium (K), rubidium (Rb), cesium (Cs), and francium (Fr).

“Group 2” elements include beryllium (Be), magnesium (Mg), calcium (Ca), strontium (Sr), barium (Ba), and radium (Ra).

“Group 3” elements include scandium (Sc) and yttrium (Y).

“Group 4” elements include titanium (Ti), zirconium (Zr), hafnium (Hf), and rutherfordium (Rf).

“Group 5” elements include vanadium (V), niobium (Nb), tantalum (Ta), and dubnium (Db).

“Group 6” elements include chromium (Cr), molybdenum (Mo), tungsten (W), and seaborgium (Sg).

“Group 7” elements include manganese (Mn), technetium (Tc), rhenium (Re), and bohrium (Bh).

“Group 8” elements include iron (Fe), ruthenium (Ru), osmium (Os), and hassium (Hs).

“Group 9” elements include cobalt (Co), rhodium (Rh), iridium (Ir), and meitnerium (Mt).

“Group 10” elements include nickel (Ni), palladium (Pd), platinum (Pt), and darmistadium (Ds).

“Group 11” elements include copper (Cu), silver (Ag), gold (Au), and roentgenium (Rg).

“Group 12” elements include zinc (Zn), cadmium (Cd), mercury (Hg), and copernicium (Cn).

“Group 13” elements include boron (B), aluminum (Al), gallium (Ga), indium (In), and thallium (Tl).

“Group 15” elements include nitrogen (N), phosphorus (P), arsenic (As), antimony (Sb), bismuth (Bi), and moscovium (Mc).

“Lanthanides” include lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu).

“Actinides” include actinium (Ac), thorium (Th), protactinium (Pa), uranium (U), neptunium (Np), plutonium (Pu), americium (Am), curium (Cm), berkelium (Bk), californium (Cf), einsteinium(Es), fermium (Fm), mendelevium (Md), nobelium (No), and lawrencium (Lr).

“Rare earth elements” include group 3 elements, lanthanides and actinides.

“Metal element” or “metal” is any element, except hydrogen, selected from Groups 1 through 12, lanthanides, actinides, aluminum (Al), gallium (Ga), indium (In), tin (Sn), thallium (Tl), lead (Pb), and bismuth (Bi). Metal elements include metal elements in their elemental form as well as metal elements in an oxidized or reduced state, for example, when a metal element is combined with other elements in the form of compounds comprising metal elements. For example, metal elements can be in the form of hydrates, salts, oxides, as well as various polymorphs thereof, and the like.

“Semi-metal element” refers to an element selected from boron (B), silicon (Si), germanium (Ge), arsenic (As), antimony (Sb), tellurium (Te), and polonium (Po).

“Non-metal element” refers to an element selected from carbon (C), nitrogen (N), oxygen (O), fluorine (F), phosphorus (P), sulfur(S), chlorine (Cl), selenium (Se), bromine (Br), iodine (I), and astatine (At).

“C2” refers to a hydrocarbon (i.e., compound consisting of carbon and hydrogen atoms) having only two carbon atoms, for example ethane and ethylene.

“C 3” refers to a hydrocarbon having only 3 carbon atoms, for example propane and propylene.

“CO₂” refers to carbon dioxide.

“CO₂” or “CO₂ compound” refers to a compound having two or more carbon atoms, e.g., two carbon atoms (C2), three carbon atoms (C3), etc. CO₂ compounds include, without limitation, alkanes, alkenes, alkynes and aromatics containing two or more carbon atoms. In some examples, CO₂ compounds include aldehydes, ketones, esters and carboxylic acids. Examples of CO₂ compounds include ethane, ethylene, acetylene, propane, propene, butane, butene, etc.

“Impurities” refer to materials that do not include alkanes, alkenes, hydrocarbons or CO₂. Examples of impurities include nitrogen (N₂), oxygen (O₂), water (H₂°), argon (Ar), hydrogen (H₂), carbon monoxide (CO).

“Conversion” means the mole fraction (i.e., percent) of a reactant converted to a product or products.

“Selectivity” refers to the percent of converted reactant that went to a specified product, e.g., CO₂ selectivity can be the % of converted methane that formed CO₂, CO₂ selectivity can also be the % of converted alkanes that formed CO₂, CO₂ selectivity can also be the % of converted alkenes that formed CO₂, CO selectivity can be the % of converted methane that formed CO.

“Yield” is a measure of (e.g., percent) of product obtained relative to the theoretical maximum product obtainable. Yield is calculated by dividing the amount of the obtained product in moles by the theoretical yield in moles. Percent yield is calculated by multiplying this value by 100. Yield is also calculable by multiplying the methane conversion or alkane conversion or alkene conversion by the relevant selectivity, e.g., CO₂ yield is equal to the methane conversion times the CO₂ selectivity.

“Alkane” means a straight chain or branched, noncyclic or cyclic, saturated aliphatic hydrocarbon. Alkanes include linear, branched and cyclic structures. Representative straight chain alkanes include methane, ethane, n-propane, n-butane, n-pentane, n-hexane, and the like; while branched alkanes include sec-butane, iso-butane, tert-butane, iso-pentane, and the like. Representative cyclic alkanes include cyclopropane, cyclobutane, cyclopentane, cyclohexane, and the like.

“Alkene” means a straight chain or branched, noncyclic or cyclic, unsaturated aliphatic hydrocarbon having at least one carbon-carbon double bond. Alkenes include linear, branched and cyclic structures. Representative straight chain and branched alkenes include ethylene, propylene, 1-butene, 2-butene, isobutylene, 1-pentene, 2-pentene, 3-methyl-1-butene, 2-methyl-2-butene, 2,3-dimethyl-2-butene, and the like. Cyclic alkenes include cyclohexene and cyclopentene and the like.

“Aromatic” means a carbocyclic moiety having a cyclic system of conjugated p orbitals forming a delocalized conjugated π system and a number of π electrons equal to 4n+2 with n=0, 1, 2, 3, etc. Representative examples of aromatics include benzene, naphthalene and toluene. “Aryl” refers to an aromatic radical. Exemplary aryl groups include, but are not limited to, phenyl, naphthyl and the like.

“Carbon-containing compounds” are compounds that comprise carbon. Non-limiting examples of carbon-containing compounds include hydrocarbons, CO and CO₂.

As used throughout the specification, a catalyst composition represented by E¹/E²/E³, etc., wherein E¹, E² and E³ are each independently an element or a compound comprising one or more elements, refers to a catalyst composition comprised of a mixture of E¹, E² and E³. E¹/E²/E³, etc. are not necessarily present in equal amounts and need not form a bond with one another. For example, a catalyst comprising Ag/CoO refers to a catalyst comprising Ag and CoO, for example, Ag/CoO may refer to a CoO catalyst doped with Ag. In some examples, the catalysts are represented by M1/M2, where M1 and M2 are independently metal elements. In such examples it is understood that the catalysts also comprise oxygen (e.g., an oxide of M1 and/or M2), although not specifically depicted. Such catalysts may also further comprise one or more additional metal elements (M3, M4, M5, etc.). By way of another example, a catalyst comprising Co₃O₄/CuO refers to a catalyst comprised of a mixture of Co₃O₄ and CuO. Dopants may be added in suitable form. For example in a silver doped coblat oxide catalyst (Ag/CoO), the Ag may be fully incorporated in the CoO crystal lattice or may reside on the surface of the CoO catalyst. Dopants for other catalyst may be incorporated analogously.

“Mixed oxide” or “mixed metal oxide” refers to a catalyst comprising at least two different oxidized metals. In various embodiments, the mixed oxides are “physical blends” of different oxidized metals. For example, in some embodiments, the mixed oxides are physical blends and are represented by M1ₓO_{z1}/M2_{y}O_{z2}, wherein M1 and M2 are the same or different metal elements, O is oxygen and x, y, z1 and z2 are numbers from 1 to 100 and the “/” indicates that the two oxidized metals are in contact (e.g., physically blended) but not necessarily bound via a covalent or ionic or other type of bond. In other examples, a mixed oxide is a compound comprising two or more oxidized metals and oxygen (e.g., M1ₓM2_{y}O_{z}, wherein M1 and M2 are the same or different metal elements, O is oxygen and x, y and z are numbers from 1 to 100).

A mixed oxide may comprise metal elements in various oxidation states and may comprise more than one type of metal element. For example, a mixed oxide of manganese and magnesium comprises oxidized forms of magnesium and manganese. Each individual manganese and magnesium atom may or may not have the same oxidation state. Mixed oxides comprising 3, 4, 5, 6 or more metal elements can be represented in an analogous manner. Mixed oxides include, but are not limited to metal oxides (MₓO_{y}), metal oxyhalides (MₓO_{y}X_{z}), metal oxynitrates (MₓO_{y}(NO₃)_{z}), metal phosphates (Mₓ(PO₄)_{y}), metal oxycarbonates (MₓO_{y}(CO₃)_{z}), metal carbonates, metal oxyhydroxides (MₓO_{y}(OH)_{z}) and the like, and combinations thereof, wherein X is independently, at each occurrence, fluoro, chloro, bromo or iodo, and x, y and z are numbers from 1 to 100. Mixed oxides may be represented herein as M1-M2, wherein M1 and M2 are each independently a metal element and M1 and M2 are oxidized. Mixed oxides comprising, 3, 4, 5, 6 or more metal elements can be represented in an analogous manner.

“Crush strength” is the force required to fracture or crush a material, such as a formed (e.g., extruded catalytic material). Crush strength can be expressed in force per length (N/mm) or force per area (N/mm²) of the material. For example, crush strength can be determined by dividing the force required to crush the material by the largest projected area of the material. For example the largest projected area of a cylinder (diameter=1 mm and length=1 mm) would be diameter multiplied by the length or 1 mm². When expressed based on material length, crush strength is determined by the force required to crush the material divided by the material length (in the direction of the applied force). This definition is applicable to formed catalysts of different sizes and shapes.

“Void fraction” or “void volume” is the volume of free space, i.e., space not occupied by the catalyst itself, divided by the total volume occupied by the catalytic form. For example, the void fraction of a ring-shaped catalyst is the volume associated with the central void (hole) divided by the total volume occupied by the ring. The void fraction or void volume of a catalyst bed (e.g., a plurality of extrudates or tableted catalytic materials) is the volume of free space associated with each individual catalyst form plus the free space associated with inter-catalyst voids divided by the total volume occupied by the catalyst bed. The calculation of free space, as described above, does not include any free space associated with the porosity of the catalytic material.

“Porosity” is the volume of void within the catalyst itself divided by the catalyst volume. For purposes of this calculation, the catalyst volume does not include any void fraction or void volume.

A catalyst that “has activity for” a certain reaction (e.g., methane combustion) refers to a catalyst that lowers the transition state, increases the reaction rate, increases conversion of reactants, increases selectivity for a certain product, or combinations thereof, under the conditions of the reaction relative to the reaction performed in the absence of the catalyst.

“Inlet Temperature” is the temperature of the incoming gas stream at the inlet of the reactor or catalytic section of the reactor or catalyst bed.

“Outlet Temperature” is the temperature of the incoming gas stream at the outlet of the reactor or catalytic section of the reactor or catalyst bed.

“Inlet Pressure” is the pressure of the incoming gas stream at the inlet of the reactor or catalytic section of the reactor or catalyst bed.

“Outlet Pressure” is the pressure of the incoming gas stream at the outlet of the reactor or catalytic section of the reactor or catalyst bed.

“Pressure Drop” is the pressure drop across the reactor as measured by taking the difference between the Outlet Pressure and the Inlet Pressure.

“GHSV” is the gas hourly space velocity of the gas stream when passing through the catalytic bed and is measured in volume of gas divided by volume of catalyst per hour.

### Catalysts

Novel catalysts which can be commercially and technically deployed in chemical systems and processes where certain molecules, typically saturated or unsaturated hydrocarbons, are decomposed at operating conditions and are considerably more favorable than those currently required by conventional catalysts are provided. Such favorable conditions may include but are not limited to: lowering the operating temperature, lowering the operating pressure, increasing the activity of the catalyst, enabling higher selectivity to CO₂, enabling higher selectivity toward oxidizers different than O₂, such as NOₓ increasing the hydrocarbon conversion, and lowering the required incoming gas stream hydrocarbon concentration. The combination of any of the above with increased stability, decreased susceptibility to poisons and/or inhibitors, and/or decreased costs relative to existing materials is an advantage that can have a significant positive impact on the environment and economics of operators.

The catalysts described herein (also referred to herein as the “active catalyst” or the “base material”) have various elemental components and activity in a variety of reactions. In certain embodiments the catalyst is an active catalyst for dilute hydrocarbon oxidation (also referred to herein as DHO active catalyst) which can increase the rate of the DHO reaction relative to the uncatalyzed DHO reaction. In other embodiments, the catalyst is an active catalyst for dilute alkane oxidation (DAO) (i.e., increases the rate of the DAO reaction relative to the uncatalyzed DAO reaction). In other embodiments, the catalyst is an active catalyst for dilute methane oxidation (DMO) (i.e., increases the rate of the DMO reaction relative to the uncatalyzed DMO reaction). DAO and DMO are subsets of the DHO reaction type. In a DHO process, a source gas comprising dilute hydrocarbons (defined below) and oxygen (O₂) is injected into a reactor containing a DHO active catalyst. In some embodiments, the source of oxygen is air. In some embodiments, the source of oxygen is NOₓ which can be catalytically converted via a three-way catalyst to N₂ and O₂. In some embodiments, the NOₓ to N₂ and O₂ reaction takes place in the same reactor where the DMO, DAO, or DHO reaction takes place. The hydrocarbons and oxygen contact the active sites within the DHO active catalyst, and the hydrocarbons are converted into CO₂. The hydrocarbons can include methane, ethane, ethylene, acetylene, propane, propylene, and hydrocarbons with four or more carbon atoms (C₄₊ hydrocarbons). The reaction's selectivity is defined as the ratio of CO₂ produced in the DHO reaction to non-CO₂ products produced in the DHO reaction. The reaction's conversion is defined as the percentage of hydrocarbons converted to any different product. In a DAO process, a source gas comprising dilute alkanes (defined below) and oxygen (O₂) is injected into a reactor containing a DAO active catalyst. In some embodiments, the source of oxygen is air. In some embodiments, the source of oxygen is NOₓ which can be catalytically converted via a three-way catalyst to N₂ and O₂. In some embodiments, the NOₓ to N₂ and O₂ reaction takes place in the same reactor where the DMO, DAO, or DHO reaction takes place. The alkanes and oxygen contact the active sites within the DAO active catalyst, and the alkanes are converted into CO₂. The alkanes can include methane, ethane, propane, and alkanes with four or more carbon atoms (C₄₊ alkanes). The reaction's selectivity is defined as the ratio of CO₂ produced in the DAO reaction to non-CO₂ products produced in the DAO reaction. The reaction's conversion is defined as the percentage of alkanes converted to any other product. In a DMO process, a source gas comprising dilute methane and oxygen (O₂) is injected into a reactor containing a DMO active catalyst. The methane and oxygen contact the active sites within the DAO active catalyst, and the methane is converted into CO₂. The reaction's selectivity is defined as the ratio of CO₂ produced in the DMO reaction to non-CO₂ products produced in the DMO reaction. The reaction's conversion is defined as the percentage of methane converted to any other product. In some embodiments, the source of oxygen is air. In some embodiments, the source of oxygen is NOₓ which can be catalytically converted via a three-way catalyst to N₂ and O₂. In some embodiments, the NOₓ to N₂ and O₂ reaction takes place in the same reactor where the DMO, DAO, or DHO reaction takes place.

The exact elemental components and/or morphological form of the catalysts are not limited, and various embodiments include different elemental compositions and/or morphologies. In this regard, catalysts useful for the practice of various embodiments of the disclosure include any bulk and/or nanostructured catalyst (e.g., nanowire) in any combination. In some embodiments, the catalyst is a bulk catalyst or a nanostructured catalyst, for example a nanowire, comprising a metal oxide, metal hydroxide, metal oxyhydroxide, metal oxycarbonate, metal carbonate or combinations thereof. Such a catalyst may optionally include one or more dopants. In some embodiments, the catalyst comprises one or more metal elements from any of Groups 1 through 7, lanthanides, actinides or combinations thereof and a dopant comprising a metal element, a semi-metal element, a non-metal element or combinations thereof.

In some embodiments, the foregoing catalyst comprises nanowire catalysts. In some embodiments, the nanowire is a polycrystalline nanowire. In some embodiments, the nanowire is a crystalline nanowire.

In some more specific embodiments, the catalyst comprises one or more elements from the lanthanides. For example, in some embodiments, the catalyst comprises La, Ce, Pr, Nd, Pm, Sm, Eu, Gd, Tb, Dy, Ho, Er, Tm, Yb, Lu or combinations thereof. In some embodiments, the catalyst comprises one or more elements from Groups 9, 10 or 11 of the periodic table. In some embodiments, the lanthanide elements or Group 9 or Group 10 or Group 11 elements are at least partially oxidized. In some embodiments, the catalyst comprises a perovskite. In some embodiments, the catalyst comprises Zn, Cu, Co, or Ag.

In some embodiments, the foregoing catalyst comprises at least one additional doping element, wherein the doping elements are selected from a metal element, a semi-metal element and a non-metal element. In other embodiments, the foregoing catalyst comprises at least two different doping elements, wherein the doping elements are selected from a metal element, a semi-metal element and a non-metal element. In some embodiments at least one of the doping elements is Fe, Pt, Pd, Ag, Cu, Ni, Ce, Zr, Zn, Co, Ar, Ga, Sr, La, Nd, Mg, Mn, Ti, V, Ru, Ir, or an element selected from any of groups 6, 7, 8, 9, 10, 11, 14, 15 or 17. In some other embodiments, the foregoing catalyst comprises combinations of two or more of the following dopants: Fe, Pt, Pd, Ag, Cu, Ni, Ce, Zr, Zn, Co, Ar, Ga, Sr, La, Nd, Mg, Mn, Ti, V, Ru, Ir. In this regard, all binary and ternary combinations of the foregoing dopants are contemplated.

In other embodiments, the catalyst disclosed herein and which is useful in various embodiments of the disclosure comprises a rare earth element (i.e., lanthanides, actinides and Group 3) in the form of an oxide, a hydroxide, or an oxyhydroxide. In certain embodiments, the rare earth element is La, Ce, Pr, Nd, Pm, Sm, Eu, Gd, Tb, Dy, Ho, Er, Tm, Yb or Y. In some embodiments, the rare earth element is La. In some other embodiments, the rare earth element is Ce. In some other embodiments, the rare earth element is Pr. In some other embodiments, the rare earth element is Nd. In some other embodiments, the rare earth element is Sm. In some other embodiments, the rare earth element is Eu. In some other embodiments, the rare earth element is Gd. In some other embodiments, the rare earth element is Yb. In some other embodiments, the rare earth element is Y.

In some more specific embodiments, the catalyst comprises a rare earth oxide such as lanthanum oxide (La₂O₃), cerium oxide (Ce₂O₃), praseodymium oxide (Pr₂O₃), neodymium oxide (Nd₂O₃), samarium oxide (Sm₂O₃), europium oxide (Eu₂O₃), gadolinium oxide (Gd₂O₃), ytterbium oxide (Yb₂O₃) or yttrium oxide (Y₂O₃).

In some more specific embodiments, the catalyst comprises a rare earth hydroxide such as lanthanum hydroxide (La(OH)₃), cerium hydroxide (Ce(OH)₃), praseodymium hydroxide (Pr(OH)₃), neodymium hydroxide (Nd(OH)₃), samarium hydroxide (Sm(OH)₃), europium hydroxide (Eu(OH)₃), gadolinium hydroxide (Gd(OH)₃), ytterbium hydroxide (Yb(OH)₃) or yttrium hydroxide (Y(OH)₃).

In some more specific embodiments, the catalyst comprises a rare earth oxyhydroxide such as lanthanum oxyhydroxide (LaOOH), cerium oxyhydroxide (CeOOH), praseodymium oxyhydroxide (PrOOH), neodymium oxyhydroxide (NdOOH), samarium oxyhydroxide (SmOOH), europium oxyhydroxide (EuOOH), gadolinium oxyhydroxide (GdOOH), ytterbium oxyhydroxide (YbOOH) or yttrium oxyhydroxide (YOOH).

In various embodiments of the foregoing catalyst comprising a rare earth element in the form of an oxide, a hydroxide or an oxyhydroxide, the catalyst may further comprise one or more dopants selected from elements in groups 10, 11 and the lanthanide series. In some embodiments the dopants are independently present in from about 1% to about 10% by weight of the catalyst. The dopants may be present in different morphologies, e.g., nanowires, nanoparticles, bulk, etc. In some embodiments, the dopants are nanowires. In some embodiments, the dopants are nanoparticles.

In some embodiments of the foregoing catalyst comprising a rare earth element in the form of an oxide, a hydroxide or an oxyhydroxide and one or more dopants selected from elements in groups 9, 10, 11 and the lanthanide series, the dopant from group 2 is Mg. In other embodiments, the dopant from group 2 is Ca. In other embodiments, the dopant from group 2 is Sr. In other embodiments, the dopant from group 2 is Ba.

In some embodiments of the foregoing catalyst comprising a rare earth element in the form of an oxide, a hydroxide or an oxyhydroxide and one or more dopants selected from elements in groups 9, 10, 11 and the lanthanide series, the dopant from group 6 is Cr. In other embodiments, the dopant from group 6 is Mo. In other embodiments, the dopant from group 6 is W.

In some embodiments of the foregoing catalyst comprising a rare earth element in the form of an oxide, a hydroxide or an oxyhydroxide and one or more dopants selected from elements in groups 9, 10, 11 and the lanthanide series, the dopant from the lanthanides is La. In other embodiments, the dopant from the lanthanides is Ce. In other embodiments, the dopant from the lanthanides is Nd.

In some other embodiments the catalyst comprises a mixed oxide of the lanthanides. In some embodiments, the mixed oxide has the following formula (I):

Ln1₄₋ₘLn2ₘO₆ (I)

### Wherein:

Ln1 and Ln2 are different lanthanide elements;

O is oxygen; and

m is a number ranging from greater than 0 to less than 4.

In some embodiments, Ln1 is La and Ln2 is Nd.

In other embodiments, the catalyst disclosed herein, which is useful in various embodiments of the disclosure comprises a perovskite. A perovskite is any material with the same type of crystal structure as calcium titanium oxide (CaTiO₃). In some embodiments, a perovskite within the context of the present disclosure has the following formula (II):

A¹_{α}A²_{β}A³_{χ}B¹_{w}B²ₓB³_{y}B⁴_{z}O₃ (II)

wherein:

A¹, A² and A³ are each independently an element from group 2;

B¹, B², B³ and B⁴ are each independently an element from group 4, group 13 or the lanthanides;

O is oxygen;

α, β and χ are each independently numbers ranging from 0 to 1, and α, β and χ are selected such that the sum of α, β and χ is about 1; and w, x, y and z are each independently numbers ranging from 0 to 1, and w, x, y and z are selected such that the sum of w, x, y and z is about 1.

In some embodiments of the perovskite of formula (II), A¹, A² and A³ are each independently Mg, Ca, Sr or Ba.

In still more embodiments of the perovskite of formula (II), B¹ is Ce, Ti, Zr or Hf.

In still more embodiments of the perovskite of formula (II), B² is Ga.

In still more embodiments of the perovskite of formula (II), B³ and B⁴ are each independently La, Nd, Eu, Gd or Yb.

In still other further embodiments of the foregoing perovskite of formula (II), when α is 1 and w is 1, the perovskite has the following formula:

A¹B¹O₃ (IIE)

In some embodiments, the perovskite of formula (IIE) comprises MgZrO₃, MgCeO₃, MgTiO₃, SrZrO₃, SrCeO₃, SrTiO₃, BaZrO₃, BaCeO₃, BaTiO₃ or BaHfO₃.

In further embodiments of the catalyst including the perovskite of formula (II), the catalyst further comprises one or more dopants which promotes catalytic activity of the catalyst. For example, in some embodiments the dopants promote catalytic activity of the catalyst in the DHO, DAO, or DMO reaction. In some embodiments, the dopants are independently present in from about 1% to about 10% by weight of the catalyst. The dopants may be present in different morphologies, e.g., nanowires, nanoparticles, bulk, etc. In some embodiments, the dopants are nanowires.

In some embodiments, the catalyst comprising the perovskite of formula (II) further comprises one or more dopants selected from elements from group 2. For example, in some embodiments, the dopant is selected from Sr, Mg, Ca or combinations thereof.

In some other embodiments, the catalyst comprising the perovskite of formula (II) further comprises one or more dopants selected from elements from group 3. For example, in some embodiments, the dopant is selected from Sc, Y or a combination thereof.

In some other embodiments, the catalyst comprising the perovskite of formula (II) further comprises one or more dopants selected from elements from group 13. For example, in some embodiments, the dopant is selected from B, Al, Ga or combinations thereof.

In some other embodiments, the catalyst comprising the perovskite of formula (II) further comprises one or more dopants selected from elements from group 15. For example, in some embodiments, the dopant is selected from P, As, Sb, Bi or combinations thereof.

In some other embodiments, the catalyst comprising the perovskite of formula (II) further comprises one or more dopants selected from elements from the lanthanides. For example, in some embodiments, the dopant is selected from La, Ce, Pr, Nd, Pm, Sm, Eu, Gd, Tb, Dy, Ho, Er, Tb, Yb, Lu or combinations thereof.

In some other embodiments, the catalyst comprising the perovskite of formula (II) further comprises one or more dopants selected from oxides of the lanthanides. For example, in some embodiments the dopant is selected from La₂O₃, Nd₂O₃, or combinations thereof. In some embodiments the catalyst further comprises a mixed oxide of the lanthanides. In some embodiments, the mixed oxide is a binary oxide of the lanthanides. For example, in some embodiments the dopant is selected from a mixed oxide of La—Nd, La—Ce, Nd—Ce, La—Sm, Nd—Sm or combinations thereof. In some embodiments, the mixed oxide is a ternary oxide. For example, in some embodiments, the dopant is selected from a mixed oxide of Ce—La—Nd, Ga—La—Ce, Ga—La—Nd or combinations thereof.

The catalysts disclosed in various embodiments herein can be in bulk form or in nanostructured form. In some embodiments, the catalyst is a nanostructured catalyst, such as a nanowire. In some embodiments, the catalyst is a nanostructured catalyst, such as a nanoparticle. In other embodiments, the catalyst is a bulk catalyst. In some embodiments, the catalyst is a combination of a nanostructured catalyst and a bulk catalyst. In some embodiments, the catalyst is a thin film coating on a support.

When used in catalytic reactions, such as the DHO, DAO, or DMO reactions, the catalysts will often be combined with a diluent or support to form a catalytic material. Such catalytic materials can be provided in any number of forms, for example as a formed catalytic material (e.g., extrudate or tableted forms).

The foregoing catalysts disclosed in various embodiments herein, when used as a heterogeneous catalyst in the DHO, DAO, or DMO reactions, the catalyst is capable of converting hydrocarbons, alkanes, or methane respectively into CO₂ with a CO₂ selectivity of at least 10%, at least 20%, at least 30%, at least 40%, at least 50%, at least 60%, at least 70%, at least 80% or at least 90% at a temperature of at least 100° C., at least 200° C., at least 300° C., at least 400° C., at least 450° C., at least 480° C., at least 490° C., at least 500° C., at least 510° C., at least 520° C., at least 550° C., at least 600° C..

The foregoing catalysts disclosed in various embodiments herein, when used as a heterogeneous catalyst in the DHO, DAO, or DMO reactions, the catalyst is capable of converting hydrocarbons, alkanes, or methane respectively into CO₂ with a methane conversion at least 5%, at least 8%, at least 10%, at least 12%, at least 14%, at least 15%, at least 18%, at least 20%, at least 22%, at least 25%, at least 30%, at least 40%, at least 40%, at least 75%, at least 85%, at least 90% or at least 95% at a temperature of at least 100° C., at least 200° C., at least 300° C., at least 400° C., at least 450° C., at least 480° C., at least 490° C., at least 500° C., at least 510° C., at least 520° C., at least 550° C., at least 600° C..

The foregoing catalysts disclosed in various embodiments herein, when used as a heterogeneous catalyst in the DHO, DAO, or DMO reactions, the catalyst is capable of converting hydrocarbons, alkanes, or methane respectively into CO₂ with a methane conversion at least 5%, at least 8%, at least 10%, at least 12%, at least 14%, at least 15%, at least 18%, at least 20%, at least 22%, at least 25%, at least 30%, at least 40%, at least 40%, at least 75%, at least 85%, at least 90% or at least 95% at a temperature of at most 200° C., at most 300° C., at most 400° C., at most 450° C., at most 480° C., at most 490° C., at most 500° C., at most 510° C., at most 520° C., at most 550° C., at most 600° C..

The foregoing catalysts disclosed in various embodiments herein, when used as a heterogeneous catalyst in the DHO, DAO, or DMO reactions, the catalyst is capable of converting hydrocarbons, alkanes, or methane respectively into CO₂ with a methane conversion at least 5%, at least 8%, at least 10%, at least 12%, at least 14%, at least 15%, at least 18%, at least 20%, at least 22%, at least 25%, at least 30%, at least 40%, at least 40%, at least 75%, at least 85%, at least 90% or at least 95% at a temperature of between 100° C. and 600° C., between 100° C. and 300° C., between 200° C. and 500° C., between 300° C. and 600° C., between 400° C. and 600° C.

The foregoing catalysts disclosed in various embodiments herein, when used as a heterogeneous catalyst in the DHO, DAO, or DMO reactions, the catalyst is capable of reaching a CO₂ selectivity of at least 10%, at least 20%, at least 30%, at least 40%, at least 50%, at least 60%, at least 70%, at least 80% or at least 90% at an inlet temperature of at least 100° C., at least 200° C., at least 300° C., at least 400° C., at least 450° C., at least 480° C., at least 490° C., at least 500° C., at least 510° C., at least 520° C., at least 550° C., at least 600° C.

The foregoing catalysts disclosed in various embodiments herein, when used as a heterogeneous catalyst in the DHO, DAO, or DMO reactions, the catalyst is capable of reaching a CO₂ selectivity of at least 10%, at least 20%, at least 30%, at least 40%, at least 50%, at least 60%, at least 70%, at least 80% or at least 90% at an inlet temperature of less than 100° C., less than 200° C., less than 300° C., less than 400° C., less than 450° C., less than 480° C., less than 490° C., less than 500° C., less than 510° C., less than 520° C., less than 550° C., less than 600° C.

The foregoing catalysts disclosed in various embodiments herein, when used as a heterogeneous catalyst in the DNNO reaction, the catalyst is capable of converting NO into NO₂ with a NO conversion of at least 5%, at least 8%, at least 10%, at least 12%, at least 14%, at least 15%, at least 18%, at least 20%, at least 22%, at least 25%, at least 30%, at least 40%, at least 40%, at least 75%, at least 85%, at least 90% or at least 95% at an inlet temperature of at most 200° C., at most 250° C., at most 300° C., at most 350° C., at most 400° C., at most 450° C., at most 500° C.

The foregoing catalysts disclosed in various embodiments herein, when used as a heterogeneous catalyst in the DNNO reaction, the catalyst is capable of converting NO into NO₂ with a NO conversion of at least 5%, at least 8%, at least 10%, at least 12%, at least 14%, at least 15%, at least 18%, at least 20%, at least 22%, at least 25%, at least 30%, at least 40%, at least 40%, at least 75%, at least 85%, at least 90% or at least 95% at a temperature of between 100° C. and 500° C., between 200° C. and 350° C., between 250° C. and 400° C., between 300° C. and 400° C., between 400° C. and 500° C.

The foregoing catalysts disclosed in various embodiments herein, when used as a heterogeneous catalyst in the DNNO reaction, the catalyst is capable of converting NO into NO₂ with a NO₂ selectivity of at least 10%, at least 20%, at least 30%, at least 40%, at least 50%, at least 60%, at least 70%, at least 80% or at least 90% at an inlet temperature of at most 200° C., at most 250° C., at most 300° C., at most 350° C., at most 400° C., at most 450° C., at most 500° C.

The foregoing catalysts disclosed in various embodiments herein, when used as a heterogeneous catalyst in the DNNO reaction, the catalyst is capable of converting NO into NO₂ with a NO₂ selectivity of at least 10%, at least 20%, at least 30%, at least 40%, at least 50%, at least 60%, at least 70%, at least 80% or at least 90% at an inlet temperature of between 100° C. and 500° C., between 200° C. and 350° C., between 250° C. and 400° C., between 300° C. and 400° C., between 400° C. and 500° C.

The foregoing catalysts disclosed in various embodiments herein, when used as a heterogeneous catalyst in the DHO, DAO, or DMO reactions, the catalyst is capable of reaching a CO₂ selectivity of at least 10%, at least 20%, at least 30%, at least 40%, at least 50%, at least 60%, at least 70%, at least 80% or at least 90% at an inlet temperature of between 100° C. and 600° C., between 100° C. and 300° C., between 200° C. and 500° C., between 300° C. and 600° C., between 400° C. and 600° C.

The foregoing catalysts disclosed in various embodiments herein, when used as a heterogeneous catalyst in the DHO, DAO, or DMO reactions, the catalyst is capable of reaching a CO₂ selectivity of at least 10%, at least 20%, at least 30%, at least 40%, at least 50%, at least 60%, at least 70%, at least 80% or at least 90% at a pressure at least above 0 barg, above at least 1 barg, above at least about 2 barg, above at least about 3 barg, above at least about 4 barg, above at least about 5 barg.

In some other embodiments, the catalyst can maintain at least 50% of the CO₂ selectivity after the catalyst is employed as a heterogeneous catalyst in the DHO, DAO, or DMO reactions for at least about 1,000 hours, at least about 2,000 hours, at least about 5,000 hours, at least about 10,000 hours or at least about 20,000 hours at gas hourly space velocity (GHSV) of at least 25,000/hr, at least 50,000/hr, at least 75,000/hr, at least 100,000/hr, at least 150,000/hr, at least 200,000/hr, at least 250,000/hr.

The foregoing catalysts disclosed in various embodiments herein, when used as a heterogeneous catalyst in the DHO, DAO, or DMO reactions, the catalyst is capable of reaching a CO₂ selectivity of at least 10%, at least 20%, at least 30%, at least 40%, at least 50%, at least 60%, at least 70%, at least 80% or at least 90% at a pressure of below at most 1 barg, below at most about 2 barg, below at most about 3 barg, below at most about 4 barg, below at most about 5 barg.

In some other embodiments, the catalyst can maintain at least 50% of the CO₂ selectivity after the catalyst is employed as a heterogeneous catalyst in the DHO, DAO, or DMO reactions for at least about 1,000 hours, at least about 2,000 hours, at least about 5,000 hours, at least about 10,000 hours or at least about 20,000 hours at gas hourly space velocity (GHSV) of at least 25,000/hr, at least 50,000/hr, at least 75,000/hr, at least 100,000/hr, at least 150,000/hr, at least 200,000/hr, at least 250,000/hr.

The foregoing catalysts disclosed in various embodiments herein, when used as a heterogeneous catalyst in the DHO, DAO, or DMO reactions, the catalyst is capable of reaching a CO₂ selectivity of at least 10%, at least 20%, at least 30%, at least 40%, at least 50%, at least 60%, at least 70%, at least 80% or at least 90% at a linear velocity about 1 m/s, about 3 m/s, about 5 m/s, about 7 m/s, about 10 m/s, about 12 m/s, about 15 m/s, about 17 m/s, about 18 m/s, about 20 m/s, about 22 m/s.

The foregoing catalysts disclosed in various embodiments herein, when used as a heterogeneous catalyst in the DHO, DAO, or DMO reactions, the catalyst is capable of reaching a CO₂ selectivity of at least 10%, at least 20%, at least 30%, at least 40%, at least 50%, at least 60%, at least 70%, at least 80% or at least 90% at a flow rate of about 250 kg/h, about 500 kg/h, about 750 kg/h, about 1,000 kg/h, about 10,000 kg/h, about 25,000 kg/h, about 50,000 kg/h, about 100,000 kg/h, about 150,000 kg/h, about 200,000 kg/h, about 250,000 kg/h, about 400,000 kg/h, about 500,000 kg/h.

The foregoing catalysts disclosed in various embodiments herein, when used as a heterogeneous catalyst in the DHO, DAO, or DMO reactions, the catalyst is capable of reaching a CO₂ selectivity of at least 10%, at least 20%, at least 30%, at least 40%, at least 50%, at least 60%, at least 70%, at least 80% or at least 90% with a pressure drop across the reactor bed of at most about 2 mBar, at most about 10 mBar, at most about 20 mBar, at most about 50 mBar, at most about 100 mBar, at most about 250 mBar, at most about 500 mBar, at most about 750 mBar, at most about 1,000 mBar, at most about 1,500 mBar, at most about 2,000 mBar, at most about 2,250 mBar, at most about 2,500 mBar.

In some embodiments, such novel catalysts described above have the potential to match or exceed the oxidation rate of conventional catalysts, normally based on PGM (platinum group metal)-based catalysts, for both saturated and unsaturated hydrocarbons. In some embodiments, such novel catalysts described above have the potential to match or exceed the oxidation rate of conventional catalysts, normally based on PGM-based catalysts for both saturated and unsaturated hydrocarbons, while utilizing temperatures that are at least 50° C. lower than those utilized by said existing materials. In some embodiments, such novel catalysts described above have the potential to match or exceed the oxidation rate of conventional catalysts, normally based on PGM-based catalysts, for both saturated and unsaturated hydrocarbons, while utilizing pressures that are at least 0.5 barg lower than those utilized by said existing materials. In some embodiments, such novel catalysts described above have the potential to be resistant to poisons for conventional catalysts, normally based on PGM-based catalysts, such as steam or sulfur containing compounds, and therefore have much longer lifetimes than conventional catalysts and/or can operate on gas streams which are too impure to risk contacting with PGM-based catalysts. In some embodiments, such novel catalysts described above have the potential to have higher performance (yield, conversion, and/or selectivity to CO₂) than conventional PGM-based catalysts, while at lower methane concentration, or alkane concentration, or hydrocarbon concentrations that are typically required. In some embodiments, the novel DHO, DAO, or DMO catalyst is capable of reaching a CO₂ selectivity of at least 10%, at least 20%, at least 30%, at least 40%, at least 50%, at least 60%, at least 70%, at least 80% or at least 90% at a methane, alkane, or hydrocarbon (respectively) concentration of less than 5 mol %, less than 2.5 mol %, less than 1 mol %, less than 0.5 mol %, less than 0.1 mol %, less than 0.05 mol %, less than 0.01 mol %, or less than 0.005 mol %.

In some embodiments, the novel catalysts described herein could also potentially match or exceed the performance of conventional three-way catalysts. Three-way catalysts are typically installed on the exhaust line of rich-burn internal combustion engines running around stoichiometric conditions, so in the absence or scarcity of oxygen, but in the presence of NOₓ, which acts as the hydrocarbons oxidizer. Conventional three-way catalysts need to operate in a very narrow operating range around stoichiometric conditions to efficiently perform the typical redox reactions of a three-way catalyst, comprising performing the three reactions simultaneously of: oxidation of hydrocarbons, oxidation of carbon monoxide, and reduction of nitrogen oxides. Conventional three-way catalyst oxidation rates drop rapidly as oxygen concentration rises. Such novel catalysts described herein can maintain a higher oxidation rate in a larger concentration window than conventional three-way catalysts, thus securing an acceptable performance in a wider range of operating conditions by oxidizing the hydrocarbons slip generated in non-stoichiometric conditions.

Compared with conventional catalysts, one of the main advantages of novel catalysts described herein is their lower light-off temperature to perform oxidation reactions, which translates into higher activity across a wider temperature range. As a result, it would be possible to quantitatively oxidize hydrocarbons at a lower energy level of the carrier stream, when compared to conventional catalysts. Because of their lower operating temperatures, the novel catalysts described herein have the potential to have considerably longer lifetimes than conventional catalysts.

### Catalytic Formulations

For implementation of the various methods described herein, the catalysts may be used alone or the catalysts may optionally be combined with one or more binder, support, diluent and/or carrier material to form catalytic materials. Catalytic formulations useful in various embodiments are described herein below.

In some embodiments, the catalytic material comprises a DHO, DAO, or DMO active catalyst and a support. The DHO, DAO, or DMO active catalyst can be any of catalysts described herein. In some embodiments, the DHO, DAO, or DMO active catalyst includes a nanowire catalyst, a bulk catalyst, or both. The nanowires exhibit good adhesive properties, and thus are useful in a membrane reactor. The support is porous and has a high surface area. The DHO, DAO, or DMO active catalyst is chemically or physically bound to the support. The support thus acts as an inert and porous host for the DHO, DAO, or DMO active catalyst. In the supported catalyst, the DHO, DAO, or DMO active catalyst is primarily located on the gas-accessible surface of the support rather than in the bulk of the support which is not accessible to gases, thereby allowing the DHO, DAO, or DMO active catalyst being accessible to gases and participating in the DHO, DAO, or DMO reaction directly.

To be usable as a support for the DHO, DAO, or DMO active catalyst, the support has to be permeable to gases and thermally stable so that no phase transition and/or reactions with the components of the reactor inlet streams occur at the operating temperature (up to 600° C.). In some embodiments, the support has to maintain stability above the operating temperature to account for excursions and so must be stable up to 900° C. The support also needs to have a similar thermal expansion coefficient to the other layers.

Several structural parameters of the support that influence the performance of the DHO, DAO, or DMO active catalyst include pore size distribution, mean or modal pore diameter, support geometry, surface area and particle size. One way in which the structure of the support influences the DHO, DAO, or DMO reaction is by changing the diffusion, heat and mass transfer characteristics of reactants and products to and from the catalytic sites, respectively. As the DHO, DAO, or DMO reaction involves multiple parallel and sequential kinetic pathways, the selectivity for CO₂ hydrocarbons is governed in part by the time in which a reactant or product is adjacent to a catalytic site. The ability for reactants to access these catalytic sites and for products to diffuse away from these catalytic sites is influenced by the structure of the catalyst, which can be controlled via the structure of the support.

The support has to be stable and does not undergo decomposition densification, and/or phase change under a DHO, DAO, or DMO reaction temperature. Further, the support has to remain stable after a given time of operation under the DHO, DAO, or DMO reaction temperature. The DHO, DAO, or DMO reaction temperature may be characterized by the inlet temperature of the catalyst bed, by the maximum temperature the catalyst experiences within the bed, or an average temperature of the bed. The stability of the support can be determined by measuring the CO₂ selectivity or methane conversion or other mechanical properties such as pressure drop, as a function of time in operation, or by analysis of the DHO, DAO, or DMO active catalyst ex-situ via tools such as X-ray diffraction, porosimetry, N₂ adsorption, microscopic or spectroscopic methods.

In some embodiments, the support is provided to have a purity greater than about 10%, greater than about 20%, greater than about 30%, greater than about 40%, greater than about 50%, greater than about 60%, greater than about 75%, greater than about 85%, greater than about 90%, greater than about 95%, or greater than about 98%. Using high purity support material helps to improve the stability of the support. The purity of the support may be characterized by the refinement of a powder X-ray diffraction pattern or other analytical methods.

In some embodiments, the stability of the support is characterized by the change in CO₂ selectivity of the catalytic material with time in operation. The CO₂ selectivity of the catalytic material after 1,000 hours of operation, 5,000 hours of operation, 10,000 hours of operation, 15,000 hours of operation, 20,000 hours of operation, 25,000 hours of operation, or 40,000 hours of operation is at least 99% of its initial selectivity, at least 95% of its initial selectivity, at least 90% of its initial selectivity, at least 80% of its initial selectivity, at least 70% of its initial selectivity, at least 60% of its initial selectivity, or at least 50% of its initial selectivity.

In some other embodiments, the stability of the support is characterized by the change in yield of the catalytic material with time in operation. The yield of the catalytic material after 1,000 hours of operation, 5,000 hours of operation, or 10,000 hours of operation is at least 99% of its initial yield, at least 95% of its initial yield, at least 90% of its initial yield, at least 80% of its initial yield, at least 70% of its initial yield, at least 60% of its initial yield, or at least 50% of its initial yield.

In some embodiments, the support comprises alumina, zirconia, cordierite, or other ceramics. In some further embodiments, the support comprises alumina such as alpha phase alumina, gamma phase alumina, or combinations thereof. In some further embodiments, the support comprises zirconia. In some embodiments, the zirconia is stabilized with Y, Ce and/or Al.

The DHO, DAO, or DMO active catalyst is disposed on, impregnated in, or a combination thereof, the support. In some embodiments, the resulting catalytic material comprises a surface area ranging from 0.1 to 200 m²/g, or from about 1 to 50 m²/g. In other embodiments, the resulting catalytic material comprises a much lower surface area, e.g., from about 0.0001 m²/g to 0.1 m²/g, or higher surface areas, e.g., from about 200 m²/g to 2000 m²/g. In some embodiments, the catalytic material comprises a pore volume fraction (i.e., the fraction of the total volume residing in pores) ranging from 5% to 90% or from about 20 to 90%.

The optimum amount of DHO, DAO, or DMO active catalyst present on the support depends, inter alia, on the catalytic activity of the catalyst. In some embodiments, the amount of catalyst present on the support ranges from 1 to 100 parts by weight of catalyst per 100 parts by weight of support or from 10 to 50 parts by weight of catalyst per 100 parts by weight of support. In other embodiments, the amount of catalyst present on the support ranges from 100 to 200 parts by weight of catalyst per 100 parts by weight of support, 200 to 500 parts by weight of catalyst per 100 parts by weight of support, or 500 to 1000 parts by weight of catalyst per 100 parts by weight of support.

The support helps to increase the stability of the DHO, DAO, or DMO active catalyst. In some embodiments, the catalytic material is capable of maintaining at least 90% of the initial CO₂ selectivity after the catalytic material is employed as a heterogeneous catalyst in the DHO, DAO, or DMO reactions for at least about 1,000 hours, at least about 2,000 hours, at least about 5,000 hours, at least about 10,000 hours or at least about 20,000 hours. In some other embodiments, the catalytic material is capable of maintaining at least 90% of the CO₂ selectivity after the catalytic material is employed as a heterogeneous catalyst in the DHO, DAO, or DMO reactions for at least about 1,000 hours, at least about 2,000 hours, at least about 5,000 hours, at least about 10,000 hours or at least about 20,000 hours at GHSV of at least 25,000/hr, at least 50,000/hr, at least 75,000/hr, at least 100,000/hr, at least 150,000/hr, at least 200,000/hr, at least 250,000/hr.

In some embodiments, the diluent comprises alkaline earth metal compounds, for example, alkaline metal oxides, carbonates, sulfates or phosphates. Examples of the diluent useful in various embodiments include, but are not limited to, MgO, MgCO₃, MgSO₄, Mg₃(PO₄)₂, MgAl₂O₄, CaO, CaCO₃, CaSO₄, Ca₃(PO₄)₂, CaAl₂O₄, SrO, SrCO₃, SrSO₄, Sr₃(PO₄)₂, SrAl₂O₄, BaO, BaCO₃, BaSO₄, Ba₃(PO₄)₂, BaAl₂O₄ and the like. In some specific embodiments, the diluent is MgO, CaO, SrO, MgCO₃, CaCO₃, SrCO₃ or combination thereof.

In other embodiments, the diluent comprises Al₂O₃, SiO₂, TiO₂, ZrO₂, ZnO, LiAlO₂, MgAl₂O₄, MnO, MnO₂, Mn₃O₄, La₂O₃, CeO₂, Y2O₃, HfO₂, AlPO4, SiO₂/Al₂O₃, B₂O₃, Ga₂O₃, In₂O₃, B₄SrO₇, activated carbon, silica gel, zeolites, activated clays, activated Al₂O₃, SiC, diatomaceous earth, aluminosilicates, support nanowires or combinations thereof.

In some embodiments, the diluent has none to moderate catalytic activity at the temperature the DHO, DAO, or DMO active catalyst is operated. In some other embodiments, the diluent has moderate to large catalytic activity at a temperature higher than the temperature at which the DHO, DAO, or DMO active catalyst is operated. In yet some other embodiments, the diluent has none to moderate catalytic activity at the temperature at which the DHO, DAO, or DMO active catalyst is operated and moderate to large catalytic activity at temperatures higher than the temperature at which the DHO, DAO, or DMO active catalyst is operated. Typical temperatures for operating a DHO, DAO, or DMO reaction according to the present disclosure are 600° C. or lower, 550° C. or lower, 500° C. or lower, 450° C. or lower, 400° C. or lower, 300° C. or lower, or 200° C. or lower.

In various embodiments of the foregoing, the diluent has a morphology selected from bulk (e.g., commercial grade), nanostructure (nanowires, nanorods, nanoparticles, etc.) or combinations thereof. In some embodiments, the diluent is nanostructured. For example, nanowires are employed as diluents in various embodiments. In some of these embodiments, the nanowires comprise one or more of the foregoing diluent materials which are amenable to formation of nanowires. For example, in some embodiments the diluent nanowires comprise a metal oxide.

In some embodiments, the diluent portion in the catalyst/diluent mixture is about 0.01%, 10%, 30%, 50%, 70%, 90% or 99.99% (weight percent) or any other value between 0.01% and 99.9%. In some embodiments, the dilution is performed with the DHO, DAO, or DMO active catalyst ready to go, e.g., after calcination. In some other embodiments, the dilution is performed prior to the final calcination of the catalyst, i.e., the catalyst and the diluent are calcined together. In yet some other embodiments, the dilution can be done during the synthesis as well, so that, for example, a mixed oxide is formed. In still more embodiments, the catalyst diluent composition is homogenized in a maximally dispersed state.

In certain embodiments, DHO, DAO, or DMO active catalyst to diluent ratio ranges from 5:95 to 95:5 (mass basis) in order to fulfill the desired performance criteria of managing localized temperature, catalyst activity and mechanical properties of the catalytic material. These criteria can vary within the catalyst packed bed or monolith support, as a function of location within the bed. For example, for a fixed bed reactor with a large temperature rise through the reactor bed from inlet to outlet, a larger or smaller active catalyst to inert diluent ratio can be applied at the reactor inlet than the ratio used at the reactor outlet.

In some embodiments, the ratio of DHO, DAO, or DMO active catalyst to diluent ranges from about 1:99 to 99:1 (mass basis), for example from about 5:95 to 95:5, from about 10:90 to about 90:10, from about 25:75 to about 75:25 or is about 50:50. The ratio of active catalyst to diluent will vary depending on the particular catalytic reaction, reaction conditions, upon mechanical strength needs, thermal control needs, catalyst activity, and other factors as described elsewhere herein. One of ordinary skill in the art will recognize how to determine the appropriate ratio. For example, in certain embodiments the appropriate ratio can be determined empirically by determining which ratios provide optimum catalytic performance and/or prevent unwanted side reactions. Further dilution of the DHO, DAO, or DMO active catalyst loading can then easily be obtained by blending forms with no catalyst with forms containing active catalyst. The forms containing no active catalyst can be bonded at much higher temperatures than the forms with active catalyst and can be typically made much more mechanically stronger than the active composite forms. The forms with no active catalyst are typically more resilient to shrinkage relative to forms with active catalyst, and thus blending of these two types of catalysts may result in a catalyst bed having reduced shrinkage.

In some embodiments, the catalyst/diluent mixture comprises more than one catalyst and/or more than one diluent. In some other embodiments, the catalyst/diluent mixture is pelletized and sized, or made into shaped extrudates or deposited on a monolith or foam, or is used as it is. Such catalytic forms are described in more detail below. Methods of embodiments of the present disclosure include taking advantage of the very exothermic nature of the DHO, DAO, or DMO reactions by diluting the catalyst with another catalyst that is completely or substantially inactive, or less active in the DHO, DAO, or DMO reaction at the operating temperature of the first catalyst but active at higher temperatures. In these methods, the heat generated by the hotspots of the first catalyst will provide the necessary heat for the second catalyst to become active.

In certain embodiments, the catalytic material comprises a first catalyst blended with a second catalyst, wherein the first and second catalysts have different catalytic activities in the same reaction under the same conditions. For example, in some embodiments the first catalyst is a nanowire catalyst, and in other embodiments the second catalyst is a bulk catalyst. In other embodiments, each of the first and second catalysts is a nanowire catalyst. In still other embodiments, both first and second catalysts are bulk catalysts.

The catalytic materials may also be employed in any number of forms. In this regard, the physical form of the catalytic materials may contribute to their performance in various catalytic reactions. In particular, the performance of a number of operating parameters for a catalytic reactor is impacted by the form in which the catalyst is disposed within the reactor. As noted elsewhere herein, the catalyst may be provided in the form of discrete particles, e.g., pellets, extrudates or other formed aggregate particles, or it may be provided in one or more monolithic forms, e.g., blocks, honeycombs, foils, lattices, etc. These operating parameters include, for example, thermal transfer, flow rate and pressure drop through a reactor bed, catalyst accessibility, catalyst lifetime, aggregate strength, performance, and manageability.

In a certain embodiment, the form of the catalyst can directly impact the flow rate and pressure drop through a catalyst bed. In particular, the pressure drop across a catalyst bed, which can be estimated using the Ergun equation, is a function of the bed void volume, where increased void spaces, e.g., between catalyst particles, provide easier flow through the catalyst bed, and thus a smaller pressure drop across the catalyst bed. Pressure drop across the bed is also a function of size of the formed catalyst particles as defined by the effective particle diameter. In accordance with preferred low pressure DHO, DAO, or DMO reactions described herein, it is desirable to maintain an entire reactor system at pressures and other operating conditions that are more conventionally found in engines, mines, and other industrial dilute methane gas processing systems. As such, it is desirable to provide reactor systems that operate at inlet pressures of from about 0 psig to about 90 psig with relatively controlled pressure drops across the reactor bed. Thus, in accordance with certain embodiments, catalyst forms are selected to provide the reactors that have inlet pressures of between about 0 and 90 psig, with pressure drops that average between about 0.001 psig/linear foot of reactor bed depth to about 0.1 psig/linear foot of reactor bed depth. Typically the catalytic form is chosen such that the pressure drop across a bed comprising the catalytic forms will range from about 0.0025 bar/m to about 2.5 bar/m at GHSV ranging from about 25,000/h at STP to about 250,000/h at STP. At constant GHSV the pressure drop will typically increase as the length/diameter aspect ratio of the catalyst bed increases and/or the diameter of the catalyst bed decreases. Typical catalyst bed aspect ratios (length to diameter) range from about 0.1 to about 20, 1 to about 3, from about 0.3 to about 1, for example about 0.5 to about 7.5.

A variety of catalyst forms may be used to achieve these parameters as described herein. In particular, catalyst forms that provide void fractions within the reactor of from about 35% to about 90%, and preferably between about 45% and about 85%, will generally provide void fractions in an advantageous range. In some embodiments, the void fraction ranges from 60% to 80%, for example from 64% to 67%. Notwithstanding the foregoing, a range of effective void fractions may be selected by selecting the appropriate particle size or honeycomb support design to meet the desired pressure drop while still providing the requisite catalytic activity.

In accordance with certain embodiments, the foregoing parameters are adjusted in the context of maintaining other parameters in desired ranges. In particular, adjustment of void fraction and pressure drop is generally carried out in a manner that does not significantly adversely affect catalytic activity or catalyst lifetime. In particular, preferred catalyst forms will provide desired pressure drops, while also providing desired performance activity and meeting mechanical properties specifications. In general, catalyst forms that provide higher surface to volume ratios, while maintaining desired void fractions, are preferred. Surface to volume ratios increase as the effective particle diameter decreases. Therefore, it is desirable to have as small an effective diameter as possible while still meeting the pressure drop requirements. Surface to volume ratios increase as the cells per square inch increase in a monolithic form. Forms with smaller effective diameters can be used, but the void fraction must increase to meet pressure drop requirements. In certain embodiments, catalyst forms that accomplish this include, e.g., rings, pentagons, ovals, tubes, trilobes, trilobe rings, wagon wheels, monoliths, quadralobes, and quadralobe rings. In general, the surface area to volume ratio for the formed aggregate catalyst particles of the disclosure will range from about 0.1 mm⁻¹ to 10 mm⁻¹, and in some embodiments from about 0.5 mm⁻¹ to about 5 mm⁻¹ and in other embodiments from about 0.1 mm⁻¹ to about 1 mm⁻¹.

In a further aspect, it is also desirable that the catalyst forms used will have crush strengths that meet the operating parameters of the reactor systems. In particular, a catalyst crush strength should generally support both the pressure applied to that particle from the operating conditions, e.g., gas inlet pressure, as well as the weight of the catalyst bed. In general, it is desirable that the formed catalytic material has a crush strength that is greater than about 0.2 N/mm², and in some embodiments greater than about 2 N/mm², for example greater than about 0.5 N/mm², and preferably greater than about 2 N/mm². In some embodiments, the crush strength is greater than about 0.25 N/mm², or greater than about 1 N/mm², or greater than about 10 N/mm², or greater than about 20 N/mm². As will be appreciated, crush strength may generally be increased through the use of catalyst forms that are more compact, e.g., having lower surface to volume ratios, or that have a higher catalyst density. However, adopting such forms may adversely impact performance. Accordingly, forms are chosen that provide the above described crush strengths within the desired activity ranges, pressure drops, etc. Crush strength is also impacted through the use of binder and preparation methods (e.g., extrusion or pelleting).

In addition, in particularly preferred embodiments, the use of catalytic nanowire materials can enhance crush strength as they can operate as binders themselves, and thus impart greater structural integrity and crush strength to the catalyst particle.

In addition, in particularly preferred embodiments, the use of catalytic nanowire materials to coat monoliths or other support materials can enhance adhesion of the catalyst to the support's surface and reduce production of fines.

Another catalyst form characteristic that can impact overall reactor performance is the accessibility of the catalytic material within a catalyst particle. This is generally a function of the surface to volume ratio of the catalytic portion of a given catalyst particle. For a homogeneously dispersed catalyst, this relates to the surface:volume ratio of the entire particle, while for catalyst coated particles or forms, this would relate to the surface:volume ratio of the coating porosity of the catalyst particle. While this ratio is a function of the catalyst particle shape, e.g., spherical particles will have lower surface:volume ratios than other shapes, it can also be substantially impacted by the porosity of the catalyst particle. In particular, highly porous catalyst particles have larger effective diffusivities allowing for greater utilization of the formed catalyst in the reactor. Again, while highly porous catalyst particles may provide greater accessibility, they should generally do so while maintaining desired crush strengths, etc., which can be adversely impacted by increasing porosity. In particularly preferred aspects, catalyst particles or other forms will include a porosity of between about 50% and about 90% while maintaining the desired crush strengths above about 0.2 N/mm². In more preferred aspects, the porosity will be between about 80% and about 90%.

For example, in some embodiments the catalytic materials are in the form of an extrudate or pellet. Extrudates may be prepared by passing a semi-solid composition comprising the catalytic materials through an appropriate orifice or using molding or other appropriate techniques. Other catalytic forms include catalysts supported or impregnated on a support material or structure. In general, any support material or structure may be used to support the active catalyst. The support material or structure may be inert or have catalytic activity in the reaction of interest (e.g., DHO, DAO, or DMO). For example, catalysts may be supported or impregnated on a monolith support. In some particular embodiments, the active catalyst is actually supported on the walls of the reactor itself or structural parts of the reactor and/or exhaust system, which may serve to minimize oxygen concentration at the inner wall or to promote heat exchange by generating heat of reaction at the reactor wall exclusively (e.g., an annular reactor in this case and higher space velocities).

The surface area to volume ratio of the catalytic form is an important parameter in determining the maximal flux of reagents and product molecules entering or leaving the catalytic form. This parameter also affects the temperature gradient throughout the form since an increase in relative surface area tends to favor heat removal and minimize the thickness of the form, hence limiting peak temperatures at the core of the particle. In some cases, heat removal from the catalyst particle is not favored, such that there is a large temperature difference between the catalyst particle and the surrounding gas. In this case, a smaller catalytic form envelope surface area to catalytic form envelope volume ratio is desired.

In some cases, it will be particularly desirable to provide catalytic materials in which the active catalyst material is substantially homogeneously dispersed. As used herein, homogeneously dispersed means that across a given catalyst particle, the concentration of active catalyst does not vary by more than 25%, preferably not greater than 10%. For particularly preferred materials, this is advantageously achieved through the use of catalytic nanowire materials, which provide a more uniform dispersion profile within catalyst formulations, e.g., including diluents, binders, etc.

For catalysts which are heterogeneously dispersed within the catalytic form (e.g., catalysts disposed on the surface of a support), the above mentioned ratio can become quite small (e.g., from about 0.1 to about 0.5) as effective catalyst used can be maintained by preferentially concentrating the active catalyst component at the surface of the form (e.g., adhered to surface of a support).

The total surface area (including pores) by weight of the catalytic form is primarily determined by the composition (i.e., catalyst, binder, diluent, etc.) of the form. When a low surface area diluent is used, then most of the surface area of the solid comes from the DHO, DAO, or DMO active catalyst. In certain embodiments, the surface area of the catalytic materials ranges from about 0.1 m²/g to about 50 m²/g, depending on catalyst dilution when using low surface area diluent material.

One of the advantages of catalytic materials employing nanowire structured catalysts is that they can form aggregates with large pore volume, presenting interconnected large pores. Typically pore volume fraction in catalytic materials containing a nanowire catalyst ranges from 20 to 90% (vol/vol) and, in some embodiments can be modified by adjusting the ratio of diluent (typically lower porosity and lower surface area) to nanowire aggregates, and in other embodiments can be modified by selecting nanowires with the appropriate aspect ratio. When the pore structure is mostly dominated by the nanowire aggregates, pores above 20 nm are the main source of pore volume within the composite form. Some embodiments include catalytic forms which have highly interconnected and large openings relative to reagent and product molecules, thus promoting diffusion through the form. This property can also be used when reactant flow is forced through the composite as for example in wall through flow monoliths for diesel soot removal.

In another embodiment, the thermal transfer properties of the catalytic form are controlled by heterogeneous loading of active catalyst throughout the form. For example, in some embodiments DHO, DAO, or DMO active catalyst can be coated upon a catalytically inert support, resulting in an overall low catalyst loading per form and limited temperature gradient through the form (since there is no heat generation in the core of the particle). Again, the thickness of such coating layers will depend upon the desired ratio of catalyst to inert support and/or catalyst loading. In other embodiments, it may be desirable to increase the temperature gradient through the form in some locations of the pack-bed reactor. In this case, an active catalyst may be preferentially loaded in the core of the form with an outer shell containing low active catalyst amounts. Such strategies are discussed in more detail below.

In some embodiments, a support (e.g., alumina or zirconia) may be used in the form of a pellet, extrudate or monolith (e.g., honeycomb) structure, and the catalysts may be impregnated or supported thereon. In other embodiments, a core/shell arrangement is provided, and the support material may form part of the core or shell. For example, a core of alumina or zirconia may be coated with a shell of catalyst. The thickness of the catalyst layer formed on the support depends on the desired rate of DHO, DAO, or DMO reaction. In some embodiments, the thickness of the catalyst layer is between 1 μm and 1000 μm, preferably between 5 μm and 100 μm, and even more preferably between 5 μm and 50 μm.

In certain embodiments, the catalytic materials are provided as a formed aggregate that comprises the underlying catalytic material, and in many cases, one or more additional materials, including dopants, diluents, binders, supports, or other different catalytic materials, as described elsewhere herein. These formed aggregates may be prepared by a large number of different forming processes, including for example, extrusion processes, casting processes, press forming processes, e.g., tablet processes, free form aggregation processes (e.g., spray aggregation), immersion, spray coating, pan coating, wash coating, or other coating or impregnation processes, atomic layer deposition, and/or agglomeration/granulation techniques. These formed aggregates may range in size from small particles, e.g., less than 1 mm in cross sectional dimension, to moderate size particles ranging from 1 mm to 2 cm in cross sectional dimension, e.g., for typical pellet or extrudate sized particles, to much larger forms, ranging from 2 cm to 1 or more meters in cross sectional dimension, e.g., for larger formed aggregates and monolithic forms.

In some embodiments, diluents or binders used for the purpose of forming composite formed aggregates containing a heterogeneous catalyst (e.g., a DHO, DAO, or DMO active catalyst) are selected from silicon carbide, magnesium oxide, calcium oxide, alumina, aluminosilicates, carbonates, sulfates, low acidity refractory oxides such as cordierite (Mg₂Al₄Si₅O₁₈) and alkaline earth metal aluminates (e.g., CaAl₂O₄, Ca₃Al₂O₆). In other embodiments, the diluents are selected from one or more of the diluents described in the foregoing section entitled “Catalytic Formulations.” The diluents are preferentially of low surface area and low porosity in order to minimize potential negative interaction between the diluent surface and the reaction product intermediates.

Additional binders can also be used in order to improve the mechanical strength (in particular crush strength) of the formed aggregates. In some embodiments, such binders are inorganic precursors or inorganic clusters capable of forming bridges between the particles in the aggregate, for example, colloidal oxide binders such as colloidal silica, alumina or zirconia may be used. In certain embodiments the catalytic materials comprise a catalytic nanowire and substantially no binder (i.e., the nanowires act as binder material). In some embodiments, the binder may comprise CeO₂.

Apart from the above mentioned components, further components and auxiliaries are typically added to the mixture to be formed (e.g., extruded). Water and, if appropriate, acids or bases may be employed. In addition, organic and inorganic substances which contribute to improving processing during formation of the catalytic form and/or to a further increase in the mechanical strength and/or the desired porosity of the extruded catalytic material can additionally be employed as auxiliaries. Such auxiliaries can include graphite, stearic acid, methylstearate, silica gel, siloxanes, cellulose compounds, starch, polyolefins, carbohydrates (sugars), waxes, alginates, and polyethylene glycols (PEGs).

The ratios of active catalyst to binder to be used in the formed aggregate vary depending upon the desired final catalyst form, the desired catalytic activity and/or mechanical strength of the catalytic form and the identity of the catalyst. With regard to extrudates, the rheology of the paste to extrude can be varied to obtain the desired catalytic material.

Since reactor vessels with high aspect ratio (length/diameter ratio for cylindrical reactor) are desirable at the commercial scale, high gas linear velocity or superficial velocity is preferred in some embodiments of the DHO, DAO, OR DMO reactions at the commercial scale. As used herein, “high linear velocity” refers to linear velocities which range from about 1 m/s to about 10 m/s, or in certain embodiments from about 2 m/s to about 8 m/s and in other embodiments from about 2 m/s to about 4 m/s. Typical commercial reactor systems used for other catalytic reactions with similar dimensions run at lower space velocity and much lower linear velocities such as less than about 2 m/s or less than about 1 m/s. These high linear flow rates result in increased flow resistance for catalyst beds with small particle size and low void fraction.

Other exemplary shapes for catalytic materials described herein include “miniliths.” Miniliths are small monolithic materials having void volumes therein. The miniliths can be provided in any number of various shapes and sizes. For example, in certain embodiments minilith shapes range from cubic to cylindrical and include non-regular shapes thereof. The void volume within the miniliths can also vary in size and shape. The number of void spaces in a typical minilith will also vary from about 1 to about 10 per minilith, for example from about 3 to about 7 per minilith. In some embodiments, the void volume is cylindrical.

With respect to the size of the disclosed miniliths, various embodiments are directed to miniliths having a largest outside dimension ranging from about 10 mm to about 50 mm, for example from about 15 to about 40 mm or from about 18 mm to 25 mm. With respect to “largest outside dimension” for a minilith, this value is determined based on the smallest diameter pipe that the minilith will fit in. For example, the largest outside dimension of a cylindrical minilith will be its diameter, while for a cubic minilith this dimension will be a diagonal of one of the cubic faces.

In some embodiments, the catalyst is a DHO, DAO, or DMO active catalyst. In some embodiments, the effective diameter ranges from about 2 to about 50 mm, from about 5 mm to about 30 mm or from about 10 to about 20 mm.

The void fraction is optimized to result in optimal pressure drop and contact of the active catalyst with the reactant gases. In some embodiments, the void fraction ranges from about 0.4 to about 0.9, for example from about 0.5 to about 0.8 or from about 0.6 to about 0.7.

The density is also optimized for such factors as crush strength and porosity. For example, in certain embodiments the formed catalytic materials have a total density ranging from about 0.5 g/cm³ to about 2.0 g/cm³, for example, from about 0.8 g/cm³ to about 1.5 g/cm³ or from about 0.9 g/cm³ to 1.2 g/cm³. As used herein, the term “total density” refers to the density of the entire formed catalytic materials (i.e., including the total volume occupied by any void volume and porosity). With respect to a catalyst bed (i.e., a plurality of formed or extruded catalytic materials), the “total density” also includes inter-catalyst void volume (void volume between individual extrudates or tablets, etc.).

In other embodiments, the exotherm of the DHO, DAO, OR DMO reaction may be at least partially controlled by blending the active catalytic material with catalytically inert material, and forming (e.g., by pressing or extruding) the mixture into the desired shape, for example shaped pellets or extrudates as discussed above. In some embodiments, these mixed particles may then be loaded into a packed bed reactor. The formed aggregates comprise from about 30% to 90% pore volume and from about 1% (or lower) to 99% active catalyst (by weight). In some embodiments, the formed aggregates comprise from about 5-95% active catalyst, from about 5-90% active catalyst, from about 5-75% active catalyst or from about 5-50% active catalyst. Useful inert materials in these embodiments include, but are not limited to those described herein above. In certain specific embodiments, the inert materials are selected from SiC and cordierite.

Nanowire shaped catalysts are particularly well suited for incorporation into formed aggregates, such as pellets or extrudates, or deposition onto structured supports, for example structured supports at a thickness ranging from about 1 to about 100 microns. Nanowire aggregates forming a mesh type structure can have good adhesion onto rough surfaces. Accordingly, various embodiments of the foregoing formed catalytic materials comprise nanowire catalyst as described herein and incorporated by reference.

The mesh like structure can also provide improved cohesion in composites, improving the mechanical properties of pellets or extrudates containing the nanowire shaped catalyst particles.

### Preparation

The catalysts and catalytic materials can be prepared according to any number of methods. Non-template directed methods for preparation of nanowire catalysts may also be employed. For example, hydrothermal or sol gel methods where a slurry of a metal isopropoxide in ethanol is first prepared and filtered. The wet cake is then treated with aqueous hydroxide at temperatures of about 230° C. for 24 hours, thus resulting in nanowires.

The catalytic materials can be prepared after preparation of the individual components (i.e., catalyst, diluent, binder, support, etc.) by mixing the individual components in their dry form, e.g., blend of powders, and optionally, milling, such as ball milling, grinding, granulating, or other similar size reduction processes can be used to reduce particle size and/or increase mixing. Each component can be added together or one after the other to form layered particles. The individual components can be mixed prior to calcination, after calcination or by mixing already calcined components with uncalcined components. The catalytic materials may also be prepared by mixing the individual components in their dry form and optionally pressing them together into a “pressed pellet” or extrudate followed by calcination to above 400° C.

In other examples, the catalytic materials are prepared by mixing the individual components with one or more solvents into a suspension or slurry, and optional mixing and/or milling can be used to maximize uniformity and reduce particle size. Examples of slurry solvents useful in this context include, but are not limited to: water, alcohols, ethers, carboxylic acids, ketones, esters, amides, aldehydes, amines, alkanes, alkenes, alkynes, aromatics, etc. In other embodiments, the individual components are deposited on a support such as alumina and zirconia, or by mixing the individual components using a fluidized bed granulator. Combinations of any of the above methods may also be used.

The catalytic materials may optionally comprise a dopant. In this respect, doping material(s) may be added during preparation of the individual components, after preparation of the individual components but before drying of the same, after the drying step but before calcinations or after calcination. Dopants may also be impregnated into, or adhered onto, formed aggregates, or as layers applied upon supports for formed aggregates, prior to addition of one or more different materials, e.g., catalyst materials, diluents, binders, other dopants, etc. If more than one doping material is used, each dopant can be added together to promote homogeneous doping, or one after the other to form layers of dopants.

Doping material(s) may also be added as dry components and optionally ball milling can be used to increase mixing. In other embodiments, doping material(s) are added as a liquid (e.g., solution, suspension, slurry, etc.) to the dry individual catalyst components or to the blended catalytic material. The amount of liquid may optionally be adjusted for optimum wetting of the catalyst, which can result in optimum coverage of catalyst particles by doping material. Mixing, grinding and/or milling can also be used to maximize doping coverage and uniform distribution. Alternatively, doping material(s) are added as a liquid (e.g., solution, suspension, slurry, etc.) to a suspension or slurry of the catalyst in a solvent. Mixing and/or milling can be used to maximize doping coverage and uniform distribution. Incorporation of dopants can also be achieved using any of the methods described elsewhere herein.

In some embodiments, dopants are incorporated into catalyst base materials by contacting the catalyst base material with a solution of a metal nitrate salt (e.g., an alkaline earth metal nitrate such as strontium nitrate). In other embodiments, dopants are incorporated using a carbonate, sulfate, phosphate or halide salt of the dopant. For example preparing a mixture comprising a catalyst base material and a carbonate, sulfate, phosphate or halide salt of the dopant, and calcining the mixture at temperatures below about 400° C. or even as low as 350° C.

The catalytic materials may optionally comprise a support such as alumina or zirconia. In this respect, the catalytic material can be formed in-situ upon calcination of a catalytically active material precursor. The support can be soaked in a solution comprising the active material precursor in order to impregnate the support with the precursor. This can be done in a solvent such as water, methanol, ethanol, acetone, or other solvents that can solubilize the precursor. The precursor can be in the form of a metal salt that comprises a metal cation and an inorganic or organic anion (e.g., nitrate, chloride, chromate, dichromate, permanganate, sulfate, acetate, citrate, cyanide, fluoride, nitrite, oxide, phosphate, methoxides, phosphonates, hydrazinium salts, urates, diazonium salts, oxalates, tartrates, iminium salts, and trolamine salicylate). In some embodiments, the catalyst may be formed by impregnation of multiple species of active material precursors into the support. Alternatively, in some embodiments, the active catalytic components can be slurry deposited or spray dried.

In some embodiments, the support may be dried or activated prior to impregnation with the active material precursor. After impregnation, the impregnated support can be calcined to produce a catalytic material comprising a DHO, DAO, or DMO active catalyst. In some other embodiments, the support can optionally be impregnated with active material precursors with subsequent soakings in a solution of the active material precursor in order to increase the loading of the active components in the catalytic material.

### Reactors

In some embodiments, the novel catalyst materials and forms described herein are incorporated in existing catalytic converters or reactors currently utilized by conventional PGM catalysts or three-way catalysts. In some embodiments, the novel catalyst materials and forms described herein are incorporated in fixed bed reactor systems. In some embodiments, the novel catalyst materials and forms described herein are incorporated in isothermal reactor systems. In some embodiments, the novel catalyst materials and forms described herein are incorporated in adiabatic reactor systems. In some embodiments, the novel catalyst materials and forms described herein are incorporated in refractory lined reactor systems. In some embodiments, the novel catalyst materials and forms described herein are incorporated in monolithic reactor systems. In some embodiments, said monoliths are sealed/packed with refractory fibers papers or thermal mats. In some embodiments, the novel catalyst materials and forms described herein are incorporated in reactor systems which are inline with existing 2-stroke lean burn engines and 4-stroke lean burn engines. In some embodiments, the novel catalyst materials and forms described herein are incorporated in reactor systems which are inline with existing rich burn engines.

### Systems/Applications

Since they are not based on PGMs or equivalently sensitive metals and catalysts, the novel catalyst materials and forms described herein have a considerably higher tolerance to typical poisons and inhibitors, such as sulfur and water. This property leads to the following advantages, both for the systems and methods that utilize these novel materials and for the upstream system and methods, i.e., the system and methods that generate the hydrocarbon-containing stream that is to be treated. Upstream systems and methods can be designed with a reduced number of equipment and/or reduced size of the equipment that is intended to either pre-treat the gas stream (in order to remove said poisons and inhibitors or to reduce their concentration within the limits tolerated by existing materials) or to control the operations of such upstream systems and methods within a narrow operating window. The operating conditions of the upstream systems and methods are no longer constrained by the requirements of the downstream hydrocarbon-oxidizing catalysts; thus they can be operated in a considerably larger operating window, usually at operating conditions that are advantageous for their efficiency or lifetime. The novel catalyst materials and forms described herein enable the treatment of hydrocarbon streams that would otherwise be either technically impossible or economically not viable, such as the oxidation of methane in the exhaust of engines.

For example, an internal combustion engine can be designed with less stringent control equipment for its stoichiometric oxygen injection; fewer pieces of equipment could be installed upstream to remove poisons and inhibitors from the fuel utilized by said engine; and said engine can be operated at a lower exhaust temperature and/or with higher water content in the exhaust, typically one that corresponds to its maximum efficiency, while maintaining the capability of oxidizing the hydrocarbons present in the exhaust stream, said engine can be equipped with a catalytic converter based on the novel materials that can oxidize methane in addition to the other hydrocarbons present in the exhaust stream, and said engine can have a simpler and more efficient design. The use of catalytic converters equipped with novel materials described herein would enable the utilization of such fuels, including renewable fuels like biogas, biomethane and the like, by making technically viable the nearly complete oxidation of the hydrocarbons resulting from the combustion of such fuels. In addition to this advantage, the use of the novel materials with standard fuels—such as natural gas—will open the possibility to oxidize exhaust hydrocarbon species that are either not currently regulated in these applications, such as methane or are addressed by means of technologies economically unviable or energetically inefficient.

Mining processes often release hydrocarbons to the atmosphere as a result of either i) ventilation systems used to extract hydrocarbons and other potentially poisonous or dangerous species from the atmosphere inside the mines; or ii) leaks of hydrocarbons naturally contained within the rock strata and seams that are subject to mining. For example, hydrocarbons, particularly methane, trapped in coal seams are released to the atmosphere during mining and post-mining activities due to leaks from the gas extraction pipes or untreated vents of mine shafts ventilation. Due to their improved performance characteristics as described above, the novel catalyst materials and forms described herein can be advantageously utilized for the decomposition of such hydrocarbons via catalytic oxidation. Due to their lower light-off temperature compared to existing catalysts, the novel catalyst materials and forms described herein can be operated at temperatures below the self-ignition temperature range of methane (500-600° C.), thus reducing energetic costs associated with the heating of the gas stream and providing an intrinsic layer to the safety of the system. Additionally, the increased tolerance of such novel catalyst materials and forms described herein to reaction inhibitors, as water-humidity, and poisons, such as sulfur, that are usually present in the process stream carrying the hydrocarbons to be oxidized, enables their application in a wider range of operating conditions and increases the lifetime of such systems.

Industrial processes that extract, refine and transport hydrocarbons as product and utilize the same hydrocarbons as fuel for their facilities routinely discharge to the atmosphere emissions of such hydrocarbons as off-gas, vents or leakages from the equipment being operated. A typical example is the natural gas leaks from the piston rod packages of reciprocating compressors and shaft seals of centrifugal compressors, or the hydrocarbons emissions resulting from the blow-by of fuel into the crankcase of the engines used to drive pumping machinery. The novel catalyst materials described above which quantitatively oxidize the hydrocarbons contained in such fugitive streams at milder operating conditions than those necessary with traditional PGM catalyst, such as at the temperature and pressure of the exhaust from natural gas and diesel engines, particularly at partial load, would allow the suppression of most hydrocarbons emissions of the industry by re-directing the collected leaks into the combustion air system of engines and/or catalytic oxidizers, optionally supported by external sources of energy like electricity or fuel.

In certain applications, the agricultural, chemical and food industry make use of the CO₂ contained in various process streams or in the exhausts generated by different combustion processes, as for instance from fired heaters, gas turbines or reciprocating engines. Frequently those streams have to be purified from contaminating hydrocarbons which would impair the exploitation of the CO₂ itself. The use of catalytic converters with novel catalytic processes would enable the complete oxidation of the hydrocarbons at more convenient operating conditions and without the need to utilize expensive PGM-based materials, which are also sensitive to poisons and inhibitors generated by the processes upstream.

One or more vessels containing the novel catalyst materials and forms described herein, either by themselves, or mixed with existing conventional catalytic materials such as PGMs or certain metal oxides—are connected to the gas stream containing the hydrocarbons to be oxidized. The novel catalytic material in the vessels may be in the form of co-precipitated, co-extruded and/or wash-coated pellets, monoliths or metal/fiber sheets coated with the novel material as described above. The stream containing the hydrocarbons has a temperature above the light-off temperature of the materials contained in the vessels.

Any combination of the following three methods can be used to ensure that the hydrocarbon-containing stream reaches the minimum light-off temperature:

One or more heat exchangers, in constant communication with the hydrocarbon-containing stream, are installed upstream of the vessels containing the novel catalytic material and increase the temperature of such stream above light-off. In one such configuration the heat exchangers may transfer the heat from the oxidized stream exiting the vessels to the feed stream containing the non-oxidized hydrocarbons (feed-product exchangers). In another such configuration the heat exchangers may transfer heat to the feed stream from an external source or hearting medium, such as steam or any other gas or liquid stream that is warmer than the feed stream

An electric heater or a burner can also be used, possibly in combination with any of the above heat exchangers, to increase the feed stream temperature above light-off.

Two or more vessels are in communication either with the feed stream or the effluent stream exiting one of the vessels. Such communication is established via switching valves—usually 3-way valves. At any given time during active operation, at least one of the vessels—vessel in reaction mode—is in communication with the feed stream and enables the oxidation of the hydrocarbons in the feed stream. The effluent from such vessel is fed to at least another vessel—vessel in heating mode—to heat the novel catalytic material and/or inert material inside such vessels above light-off. When the temperature of the material in the vessels in reaction mode falls below light off, valves are appropriately operated to send the feed stream to the vessels that were in heating mode and, accordingly, the effluent to the vessels that were in reaction mode.

The novel catalytic materials described herein can be technically and economically deployed for the oxidation of hydrocarbons released by their extractive and treatment processes because they can operate in intrinsically safe conditions (for example, below the auto-ignition temperature of methane) given the concentration temperatures and pressures encountered and they can maintain their catalytic activity also in the presence of poisons and inhibitors naturally contained in hydrocarbons, such as sulfur compounds.

The combustion of hydrocarbons to produce mechanical power, either for transportation or power generation, can be conducted with an amount of oxygen close to the stoichiometric level necessary for the combustion itself known as rich burn engines, or with an amount of oxygen larger than what stoichiometrically is required for the combustion process such as in turbines or lean burn engines. All of the above systems release hydrocarbons to the atmosphere in different ways, as a result of the different systems utilized for combustion and conversion of the chemical energy into mechanical power.

Lean burn engines are typically utilized for applications that require the production of considerable mechanical power, such as marine transportation, railways or power generation. These engines adopt either a compression-ignition or spark-ignition 4-stroke cycle or a compression-ignition 2-stroke cycle, depending on the specific design adopted for the operation of the engine itself. Regardless of the specific cycle, these engines release multiple classes of saturated and unsaturated hydrocarbons into the atmosphere from their exhaust stream as a result of both incomplete combustion and fuel bypass. Incomplete combustion occurs because the operating conditions that are typically achieved in the combustion chamber of these engines do not permit a complete oxidation of all hydrocarbons to CO₂ and water. Fuel bypass occurs because there is always overlap between the opening and closing phases of the engine valves, defined as valve overlap, which causes a portion of the fresh hydrocarbon feed to mix with the exhaust stream in the combustion chamber, usually because the fresh stream is injected into the combustion chamber at the same time that the exhaust leaves it, during cylinder scavenging. Another reason for fuel by-pass is the quenching effect on the fuel-air mix within the dead volumes of the cylinder-piston system and at the cold end of the combustion chamber during the gas expansion.

Existing materials are typically utilized within converters installed downstream of the combustion chambers of such engines to reduce the emissions of particular classes of hydrocarbons, specifically hydrocarbons defined in the categories of Volatile Organic Compounds (VOCs) and Hazardous Air Pollutants (HAPs). These existing materials utilize PGMs and/or conventional metal oxides to further oxidize certain species with the excess oxygen contained in the exhaust stream of lean burn engines.

The novel catalytic materials described herein can be advantageously utilized in combination with existing materials or by themselves for the abetment of all classes of hydrocarbons, including some hydrocarbons, such as methane, that are only partially oxidized or even not oxidized by the existing materials at the typical engine exhaust temperature. The use of novel catalytic materials described herein for the oxidation of saturated and unsaturated hydrocarbons via the DMO, DHA, and DAO reactions on the exhaust of lean-burn engines is advantageous because:

Due to their considerably higher activity at lower temperatures compared to existing materials, the novel catalytic materials described herein offer the possibility to oxidize all hydrocarbon compounds present in the engine exhaust, using merely the residual energy and oxygen present in the exhaust stream itself. This is especially important for the partial load operation of compression-ignition lean burn engines, where the exhaust temperature is extremely low and renders the catalytic converters based on existing materials incapable of oxidizing the hydrocarbons in the exhaust or for spark-ignition lean burn engines which also at high exhaust temperature, either at full or at partial loads, cannot reach the light-off temperature necessary to the existing materials to accomplish the oxidation of stable hydrocarbons such as methane and ethane. Due to their decreased light-off temperatures and/or pressures, the converters filled with novel catalytic materials described herein can operate at lower temperatures and/or lower pressures than the existing catalytic converters. In turn, this enables the engines to operate with a lower exhaust temperature and/or pressure with a potentially higher concentration of uncombusted hydrocarbons, which leads to a significant improvement of the engine's energy efficiency. This is especially important for natural gas engines, which have to operate at higher than optimal temperatures and minimize saturated hydrocarbons concentration in the exhaust, generated by fuel by-pass, given the difficulty of the existing catalytic materials to oxidize this compound at the exhaust conditions.

Due to their long term tolerance to reaction inhibitors, such as water, and poisons, such as sulfur, the novel catalytic materials can display significantly increased reliability when operating on the exhaust of lean burn engines, which usually contains both inhibitors such as water and poisons such as sulfur as the result of the combustion of fuels and process fluids contaminant (e.g., lube oil).

### EXAMPLES

A lean burn engine may comprise a combination of the following elements: One or more compressors injecting the combustion air into the combustion chamber of the cylinders. The timing and amount of the combustion air injection are usually carefully and continuously adjusted by a control system to maximize the engine efficiency and minimize its emissions. An injection fuel system typically comprises a tank and a pump for liquid fuels and, possibly, a compressor for gas fuels, and a system of valves that control the timing and amount of fuel and combustion air injected into the combustion chamber and the timing of the exhaust release from the cylinders. One or more cylinders each with one piston are contained in the combustion chamber where the fuel reacts with the combustion air to generate the energy required to move the piston and the systems connected to it. A pipe or similar gas conveyance system is adapted to transport the exhaust stream from the combustion chamber to the atmosphere. This gas conveyance system usually also connects to one or more turboexpanders (to recover the energy contained in the pressurized exhaust stream), one or more catalytic converters (to minimize the emissions of VOCs and HAPs, and often NOₓ, CO and Particulate Matter) and, possibly, one or more post-burners or electrical heaters to adjust the temperature within the exhaust line.

The emissions of lean burn engines can be minimized and their efficiency can be improved as described above if a catalytic converter, which contains the novel catalytic materials, optionally in combination with conventional catalyst materials, in a suitable form (including those described above and not limited to; a monolith or coated on inorganic foam or metal/fiber sheets), is added to the exhaust line of the engine in one of the following ways or combination thereof: (i) between the combustion chambers and the turbo-expanders; (ii) between the combustion chambers and the turboexpanders in combination with one or more post-burners or electrical heaters; (iii) downstream of the turboexpanders; (iv) downstream of the turboexpanders in combination with one or more post-burners or electrical heaters.

Once a catalytic converter based on the novel catalytic materials is installed in an engine according to one of the above designs, the construction and operation of the engine can be re-optimized to further minimize its emissions and maximize its efficiency. The catalytic converters based on novel catalytic materials may optionally be designed and operated with the addition of external heat sources, such as heat generated from electric power, to further control their operating temperature and achieve the optimal operating conditions at any given time.

The use of novel catalytic materials also enables the potential to avoid bypassing the catalytic converters when certain fuels are used, especially in dual fuel engines. For example, the use of Heavy Fuel Oils (HFO) often restricts the use of current catalytic materials due to their sensitivity to the poisons present in HFOs, such as high levels of sulfur. The novel catalytic materials may enable the catalytic converters to be operated with a wider range of fuels and fuel mixes given their vastly improved tolerance to such poisons.

In rich-burn 4-stroke reciprocating internal combustion engines the injection rate of fuel, whether gasoline or natural gas, is intentionally adjusted to provide hydrocarbons as a reducing agent for the conversion of nitrogen oxides (NOₓ), generated by the fuel combustion, into harmless nitrogen. Reduction of NOₓ by residual hydrocarbons and carbon monoxide, also generated by fuel combustion, is accomplished via the support of a PGM-based catalyst, commonly named “three-way catalyst”, installed downstream the engine, at the exhaust manifold. However, it is generally recognized that such three-way catalyst can properly perform only within a narrow window of operating conditions, in terms of concentrations of hydrocarbons and residual oxygen, ultimately determined by the effective “lambda”, the ratio between the actual amount of air fed to the engine and the stoichiometric amount necessary for the total fuel combustion. The aforesaid extreme sensitivity to the actual air-to-fuel ratio results in averagely higher emissions during real operation, due to transients and consequent lambda oscillations, than in steady state performance cycles. In order to mitigate the effect of the periodic variability of exhaust composition, sophisticated air-to-fuel ratio control architectures have been implemented and additives have been introduced to the catalytic recipe of three-way catalysts, with different results depending on the fuel composition.

The instability of the whole emissions control process has been demonstrated to be more significant for methane-based fuels (NG, CNG, LNG) than for heavier fuels, like LPG and gasoline. In the aforesaid framework the novel materials can be advantageously utilized in the following ways: (i) The use of novel catalytic materials can significantly expand the window of optimal operating conditions for the reduction of NOₓ with residual hydrocarbons due to their higher activity in reacting saturated hydrocarbons with NOₓ at lower temperatures when compared to existing catalytic materials. The expanded optimal operating window results in higher average engine efficiency and more time spent by the engine in a range of operating that enables the converter to fully oxidize the hydrocarbons in the exhaust; (ii) while it is extremely difficult for existing materials to oxidize methane, the use of novel materials in the catalytic converter leads to the oxidation of the fugitive methane slip, especially that generated during transient operation in lean conditions, via the reaction with the residual oxygen in the exhaust stream.

Numerous industrial processes release hydrocarbons to the atmosphere as a result of their operations, either continuously or due to transient conditions. These processes can be divided into two general categories: (i) Processes where the hydrocarbon stream released into the atmosphere is the result of combustion, generally utilized to generate heat; (ii) Processes where the hydrocarbon emissions are the byproducts of chemical processes that convert certain inputs—mostly feed hydrocarbons—into hydrocarbon products.

Examples of the first category can be found in a variety of industrial sectors, from energy to petrochemicals, specialty chemicals, refining, food processing, etc. In all these industries, a fuel stream, generally natural gas, is fed to a burner to generate heat, which is then either directly or indirectly transferred to the industrial process. For example, fired heaters are used across the energy, refining and petrochemical sectors to directly provide heat for certain chemical or physical processes or to generate steam that is used as the indirect energy carrier.

Emissions from fired heaters are generally regulated in terms of concentration and cumulative quantity over time of certain species released into the atmosphere. For example, the release of NOₓ species is regulated almost everywhere, and the environmental limits are usually achieved through the use of specific catalytic converters—SCR reactors, which are installed in the flue gas stack of the fired heaters. Depending on the specific fuel utilized by the fired heater, the profile of the hydrocarbon concentrations in the flue gas may require further treatment of the exhaust to meet the environmental thresholds for VOCs and HAPs. In some cases, however, no such treatment is viable with the current catalytic materials due to either the inability of the existing materials to oxidize the exhaust hydrocarbons or their sensitivity to poisons and inhibitors present in the flue gas. Thus, the fuels causing such emission profiles cannot be utilized with the current technology.

The use of catalytic converters equipped with the novel catalytic materials enables the utilization of such fuels by making technically viable the nearly complete oxidation of the hydrocarbons resulting from the combustion of such fuels. In addition to this advantage, the use of the novel materials with standard fuels, such as natural gas, will open the possibility to oxidize exhaust hydrocarbon species that are not currently regulated in these applications, such as methane.

Several processes release hydrocarbon streams to the atmosphere as a byproduct of chemical reactions or physical treatments that they apply to their inputs. For example, in the production of polymers such as polyethylene or polypropylene it is common to have byproduct or purge streams containing the corresponding monomers ethylene or propylene that are sent to flaring prior to being released into the atmosphere. In another example, the production of methanol derivatives such as formaldehyde generates tail gas streams containing oxygenated hydrocarbons that contain oxygen that need to be completely oxidized prior to their release in the atmosphere. In both the above cases, the use of catalytic converters based on the novel catalytic materials will enable the complete oxidation of the hydrocarbons in the offgas streams at more favorable conditions, such as lower temperatures or without the requirement for additional fuel gas.

In another example, the use of pre-oxidation catalytic reactors comprising the foregoing catalysts disclosed in various embodiments herein, when used as a heterogeneous catalyst, can enable improvements in the treatment of emissions from diesel engines. Typically, in modern diesel engine systems, a pre-oxidation reactor loaded with PGM-based catalyst is installed upstream of the soot particulate filter to increase soot oxidation and decrease soot accumulation on the filter. The exhaust from the diesel engine typically contains between 500 ppm and 1,000 ppm of nitrogen oxides, of which more than 90% is nitrogen mono-oxide (NO). It is well known that nitrogen dioxide (NO₂) can readily react with soot particulates to oxidize the soot to carbon dioxide and reduce soot emissions from the exhaust. Therefore, a pre-oxidation reactor is thus installed on the exhaust gas stream to considerably shift the nitrogen oxide equilibrium to favor formation of nitrogen dioxide, by reacting the NO with the residual oxygen contained in the exhaust (dilute NO oxidation or DNNO) over a PGM-based catalyst. The resulting additional NO₂ then oxidizes the soot particulates accumulated on the Diesel Particulate Filter (DPF), thus removing them from the DPF. The PGM-based catalysts typically loaded in the pre-oxidation converters are susceptible to poisons and inhibitors, such as sulfur or steam, which reduce their performance over time. The PGM-based catalysts also require a sufficient temperature (usually above 350° C.) to display a significant oxidation rate for NO to NO₂. While this operating temperature can be possible in the diesel engine exhaust during steady state operation of the engine, the exhaust temperature drops below this threshold in transient modes of operation, such as during “start and stop” operations common for vehicles. These modes of operations reduce the capability of the pre-oxidation converter to oxidize NO and, thus, lead to an excess of soot accumulation in the DPF.

The foregoing catalysts disclosed in various embodiments herein can show numerous improvements over the conventional PGM-based materials. In some embodiments, the foregoing catalysts disclosed in various embodiments herein can demonstrate higher NO conversion to NO₂ relative to PGM-based materials at a given temperature. In some embodiments, the foregoing catalysts disclosed in various embodiments herein can demonstrate a lower activation temperature relative to PGM-based materials. In some embodiments, these improvements enable the significant oxidation of NO to NO₂ even at temperatures below 350° C., such as “start and stop” modes of operations for vehicles. In some embodiments, the foregoing catalysts disclosed in various embodiments herein have an improved resistance to sulfur poisoning or water inhibition than PGM-based materials in the DNNO reaction.

In another example, the food processing industry often generates exhaust streams that result from the cooking of certain food ingredients for example, frying. The use of catalytic converters with the foregoing catalysts disclosed in various embodiments herein will enable the complete oxidation of the hydrocarbons in the exhaust stream without the need to utilize expensive PGM-based materials, which are also sensitive to poisons and inhibitors resulting from the industrial processes themselves.

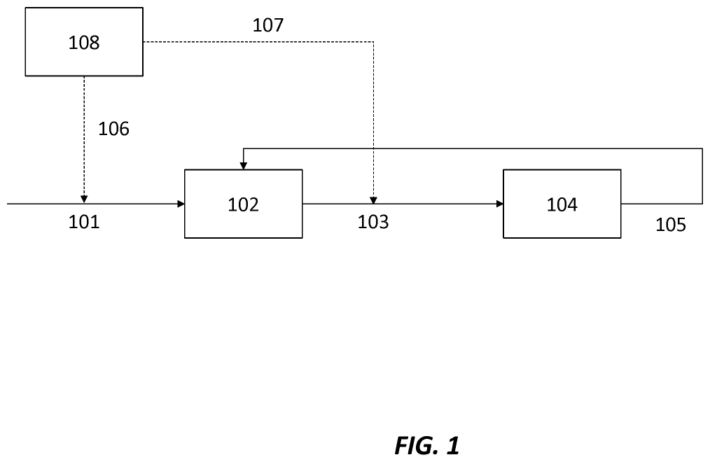

In one example described in FIG. 1 the gaseous stream 101, which contains the hydrocarbons, including but not limited to alkanes, methane, olefins, etc., to be oxidized (for example, the ventilation air coming from a coal mine shaft, or the natural gas vent coming from an oil well or a gas well), is fed to the cold side of the heat exchanger or set of heat exchangers 102. The stream 103 has the minimum light off temperature required for the operation of the catalytic converter 104, which contains the novel catalytic materials that oxidize the hydrocarbons with the oxygen contained in the stream 103. Optionally, if the oxygen contained in the stream 103 is not sufficient to achieve an adequate conversion in the converter 104, additional compressed air 106 and/or 107 can be supplied by the air fan or compressor 108. The stream 105, which exits the converter 104, has a lower hydrocarbon content and a higher temperature than stream 103. The stream 105 is then fed to the hot side of the heat exchanger 102 to heat up the stream 101.

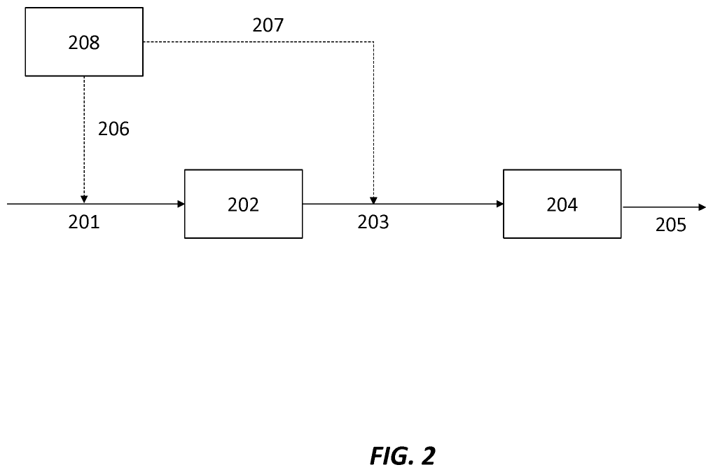

In one example described in FIG. 2 the gaseous stream 201, which contains the hydrocarbons, including but not limited to alkanes, methane, olefins, etc., to be oxidized (for example, the ventilation air coming from a coal mine shaft, or the natural gas vent coming from an oil well or a gas well), is fed to the cold side of the heat exchanger or set of heat exchangers 202. Steam or electric power provides the required heat to stream 201 in the heat exchanger 202. The stream 203 has the minimum light off temperature required for the operation of the catalytic converter 204, which contains the novel catalytic materials that oxidize the hydrocarbons with the oxygen contained in the stream 203. Optionally, if the oxygen contained in the stream 203 is not sufficient to achieve an adequate conversion in the converter 204, additional compressed air 106 and/or 107 can be supplied by the air fan or compressor 206. The stream 205, which exits the converter 204, has a lower hydrocarbon content than stream 203.

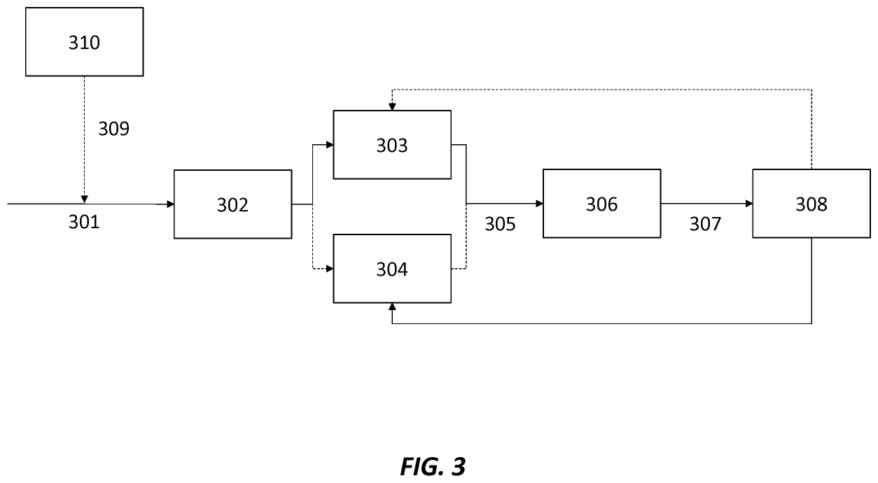

In one example described in FIG. 3 the gaseous stream 301, which contains the hydrocarbons, including but not limited to alkanes, methane, olefins, etc., to be oxidized (for example, the ventilation air coming from a coal mine shaft, or the natural gas vent coming from an oil well or a gas well), is directed to either the heat exchanger (or set of heat exchangers) 303 or the heat exchanger (or set of heat exchangers) 304 via the valve system 302 (for example, a 3-way valve). The heat exchanger (e.g., 303) that receives the stream 301 is in “process mode” while the other heat exchanger (e.g., 304) is in “heating mode”. The stream 305, which exits the heat exchanger 303 in “process mode”, has the minimum light off temperature required for the operation of the catalytic converter 306, which contains the novel catalytic materials that oxidize the hydrocarbons with the oxygen contained in the stream 305. Optionally, if the oxygen contained in the stream 301 is not sufficient to achieve an adequate conversion in the converter 306, additional compressed air 309 can be supplied by the air fan or compressor 310. The stream 307, which exits the converter 306, has a lower hydrocarbon content and a higher temperature than stream 305. The stream 307 is directed to either the heat exchanger 303 (if 303 is in “heating mode”) or to the heat exchanger 304 (if 304 is in “heating mode”) via the valve system 308 (for example, a 3-way valve).

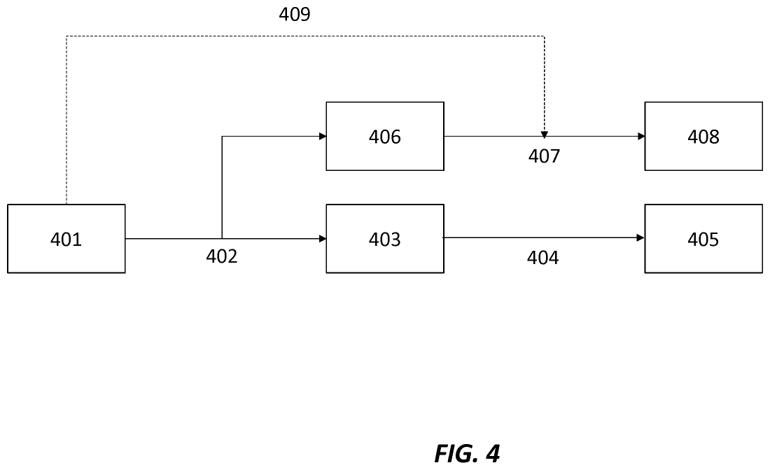

In one example described in FIG. 4 the natural gas system 401, which could be, for example, a pipeline, a gathering line or a well, feeds the natural gas stream 402 to the natural gas compressor 403. In some embodiments where the mechanical driver of the compressor 403 is a gas-fired turbine or engine, a portion of the natural gas stream 402 can be directed as fuel to the mechanical driver 406. In the case of a natural gas fired engine, the exhaust stream 407 contains uncombusted methane, other uncombusted alkanes (such as ethane, propane and butane) and combustion by-products, such as Volatile Organic Compounds (VOCs) and Hazardous Air Pollutants (HAPs). All these species are oxidized in the catalytic converter 408, which contains the novel catalytic materials, at the exhaust temperature of the stream 407. The compressed natural gas stream 404 is cooled in the heat exchanger 405. In some embodiments, the stream 409, which represents any temporary or permanent gaseous vent or blowdown from the natural gas system 401, can also be fed to the catalytic converter 408.

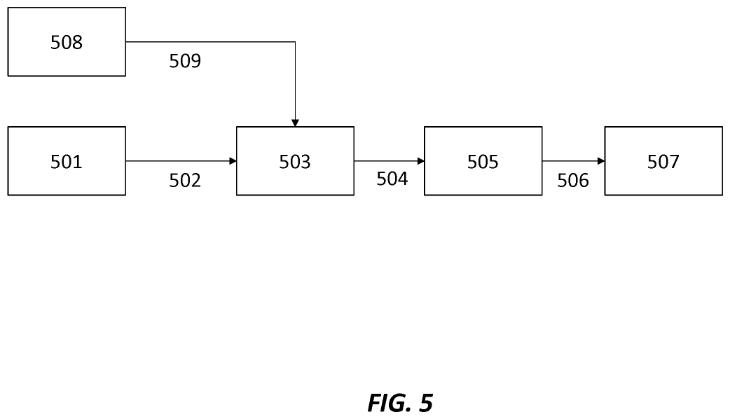

In one example described in FIG. 5 the tank 501 contains the fuel used by the engine, which can be Compressed Natural Gas (CNG), Liquefied Natural Gas (LNG), Liquefied Petroleum Gas (LPG) or any other liquid mixture of hydrocarbons that is typically used as fuel for engines (such as, but not limited to, gasoline, diesel, kerosene, jet fuel and bunker fuel). The fuel stream 502 is injected into the combustion chamber 503, together with the combustion air 509, which can be provided by a separate air compressor 508. The exhaust stream 504, which contains uncombusted hydrocarbon species and by-products of the combustion reactions (such as VOCs and HAPs), is expanded over the turbo-expander 505 forming stream 506, which is then fed to the catalytic converter 507, where the hydrocarbon species contained in the stream 504 are oxidized with the oxygen contained in the stream 504 by the novel catalytic materials.

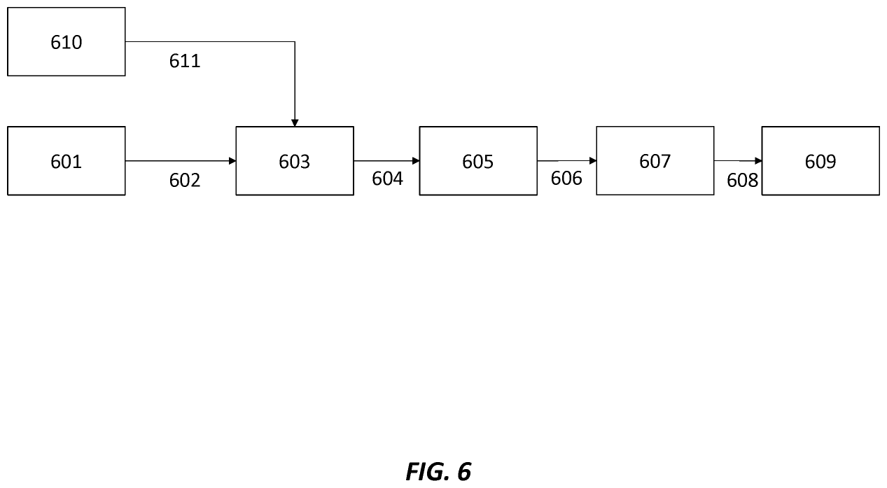

In one example described in FIG. 6 the tank 601 contains the fuel used by the engine, which can be Compressed Natural Gas (CNG), Liquefied Natural Gas (LNG), Liquefied Petroleum Gas (LPG) or any other liquid mixture of hydrocarbons that is typically used as fuel for engines (such as, but not limited to, gasoline, diesel, kerosene, jet fuel and bunker fuel). The fuel stream 602 is injected into the combustion chamber 603, together with the combustion air 611, which is usually provided by the separate air compressor 610. The exhaust stream 604, which contains uncombusted hydrocarbon species and by-products of the combustion reactions (such as VOCs and HAPs), is expanded over the turbo-expander 605 forming stream 606. The exhaust heating system 607, which, for example, can be a post-burner or an electric heater, increases the temperature of the exhaust stream above the minimum light off threshold of the novel catalysts. The heated exhaust stream 608 is fed to the catalytic converter 609, where the hydrocarbon species contained in the stream 608 are oxidized with the oxygen contained in the stream 608 by the novel catalytic materials.

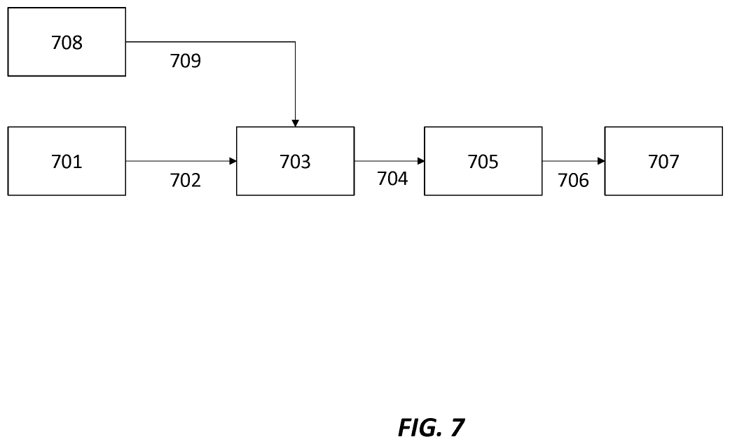

In one example described in FIG. 7 the tank 701 contains the fuel used by the engine, which can be Compressed Natural Gas (CNG), Liquefied Natural Gas (LNG), Liquefied Petroleum Gas (LPG) or any other liquid mixture of hydrocarbons that is typically used as fuel for engines (such as, but not limited to, gasoline, diesel, kerosene, jet fuel and bunker fuel). The fuel stream 702 is injected into the combustion chamber 703, together with the combustion air 709, which is usually provided by the separate air compressor 708. The exhaust stream 704, which contains uncombusted hydrocarbon species and by-products of the combustion reactions (such as VOCs and HAPs), is fed to the catalytic converter 705, where the hydrocarbon species contained in the stream 704 are oxidized with the oxygen contained in the stream 704 by the novel catalytic materials. The exhaust stream exiting the catalytic converter 706 is expanded over the turboexpander 707.

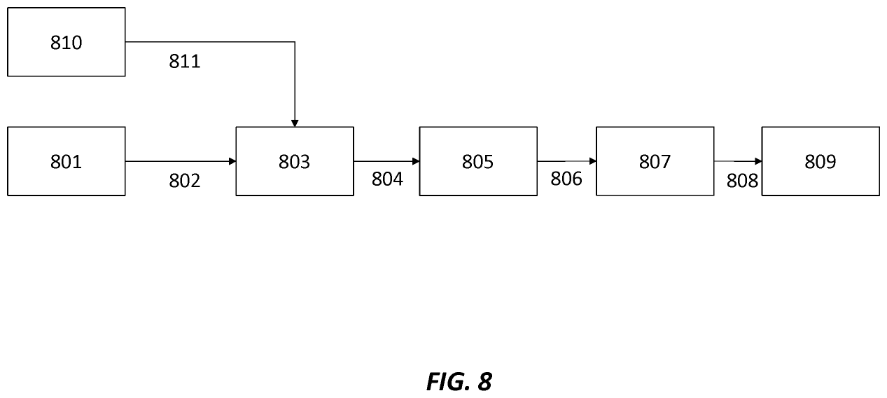

In one example described in FIG. 8 the tank 801 contains the fuel used by the engine, which can be Compressed Natural Gas (CNG), Liquefied Natural Gas (LNG), Liquefied Petroleum Gas (LPG) or any other liquid mixture of hydrocarbons that is typically used as fuel for engines (such as, but not limited to, gasoline, diesel, kerosene, jet fuel and bunker fuel). The fuel stream 802 is injected into the combustion chamber 803, together with the combustion air 811, which is usually provided by the separate air compressor 810. The exhaust stream 804, which contains uncombusted hydrocarbon species and by-products of the combustion reactions (such as VOCs and HAPs), is fed to the heating system 805, which, for example, can be a post-burner or an electric heater. The heating system 805 increases the temperature of the exhaust stream 804 above the minimum light off threshold of the novel catalysts prior to feeding the now heated exhaust stream 806 to the catalytic converter 807, where the hydrocarbon species contained in the stream 806 are oxidized with the oxygen contained in the stream 806 by the novel catalytic materials. The exhaust stream 808 exiting the catalytic converter 807 is expanded over the turboexpander 809.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A method for performing dilute methane oxidation (DMO) to convert methane into carbon dioxide (CO₂), comprising:
mixing a first gas stream comprising methane with a second gas stream comprising oxygen to form a third gas stream comprising methane and oxygen, wherein the third gas stream contains less than 5 mol % methane, and furthermore comprises oxygen in an amount at least stoichiometrically sufficient to completely oxidize the methane to CO₂; and
performing a DMO reaction by contacting the third gas stream with a DMO catalytic material in a fixed bed reactor to produce a fourth gas stream comprising CO₂ in an amount greater than that present in the third gas stream, wherein the third gas stream enters the fixed bed reactor at a pressure no greater than 5 barg and at a temperature no greater than 600° C.,
wherein the DMO catalytic material comprises a mixed lanthanide oxide and one or more dopants,
wherein the mixed lanthanide oxide comprises a plurality of nanowires, and
wherein the DMO reaction using the DMO catalytic material as a heterogeneous catalyst has a methane conversion of at least 60% and a CO₂ selectivity of at least 60% in the fixed bed reactor under the conditions thereof.

2. The method of claim 1, wherein the methane conversion is at least 80% and the CO₂ selectivity is at least 80% when the DMO catalytic material is employed as a heterogeneous catalyst contacting the third gas stream comprising methane and oxygen in the fixed bed reactor at a pressure no greater than 5 barg and at a temperature no greater than 600° C., wherein the third gas stream contains less than 5 mol % methane.

3. The method of claim 1, wherein the third gas stream enters the fixed bed reactor at a temperature no greater than 450° C.

4. The method of claim 1, wherein the DMO catalytic material maintains the methane conversion of at least 60% and the CO₂ selectivity of at least 60% in the fixed bed reactor for at least about 1,000 hours.

5. The method of claim 1, wherein the DMO catalytic material maintains the methane conversion of at least 60% and the CO₂ selectivity of at least 60% in the fixed bed reactor for at least about 1,000 hours when the third gas stream further comprises steam, sulfur, or ethane.

6. The method of claim 1, wherein the DMO catalytic material is employed as a heterogeneous catalyst contacting the third gas stream comprising methane and oxygen in the fixed bed reactor at a pressure no greater than 2 barg and at a temperature no greater than 500° C., wherein the third gas stream contains less than 2 mol % methane.

7. The method of claim 1, wherein the dopants in the DMO catalytic material comprise at least one dopant from Group 2 and at least one dopant from Groups 4, 9, 10 and 11.

8. The method of claim 7, wherein the dopant from Group 2 comprises at least one of magnesium, strontium and calcium, and the dopant from Group 4, 9, 10, or 11 comprises at least one of zirconium, copper, cobalt and nickel.

9. The method of claim 1, wherein the mixed lanthanide oxide has the following formula (I):
Ln1₄₋ₘLn2ₘO₆ (I)
wherein:
Ln1 and Ln2 are different lanthanide elements;
O is oxygen; and
m is a number ranging from greater than 0 to less than 4.

10. The method of claim 1, wherein the DMO catalytic material further comprises manganese.

11. The method of claim 1, wherein the first gas stream further comprises ethane, and wherein the second gas stream further comprises NOₓ.

12. The method of claim 1, wherein the DMO catalytic material is in a coated monolith form.

13. The method of claim 1, wherein the third gas stream is generated in a 4-stroke or 2-stroke lean burn engine in fluid contact with the fixed bed reactor.

14. The method of claim 1, wherein the third gas stream is generated in a rich burn engine in fluid contact with the fixed bed reactor.

15. The method of claim 1, wherein the third gas stream is generated in a natural gas burning engine in fluid contact with the fixed bed reactor.

16. The method of claim 1, wherein the third gas stream contains less than 1 mol % methane.

17. The method of claim 1, wherein the plurality of nanowires comprises nanowires having an aspect ratio greater than 5.

18. The method of claim 1, wherein the fourth gas stream is utilized in an industrial process or an agricultural process using CO₂ as feedstock or utility.

19. A method for performing dilute alkane oxidation (DAO) to convert alkanes into carbon dioxide (CO₂), comprising:
mixing a first gas stream comprising alkanes with a second gas stream comprising oxygen to form a third gas stream comprising alkanes and oxygen, wherein the third gas stream contains less than 5 mol % alkanes, and furthermore comprises oxygen in an amount at least stoichiometrically sufficient to completely oxidize the alkanes to CO₂; and
performing a DAO reaction by contacting the third gas stream with a DAO catalytic material in a fixed bed reactor to produce a fourth gas stream comprising CO₂ in an amount greater than that present in the third gas stream, wherein the third gas stream enters the fixed bed reactor at a pressure no greater than 5 barg and at a temperature no greater than 600° C.,
wherein the DAO catalytic material comprises a mixed lanthanide oxide and one or more dopants,
wherein the mixed lanthanide oxide comprises a plurality of nanowires, and
wherein the DAO reaction using the DAO catalytic material as a heterogeneous catalyst has an alkane conversion of at least 60% and a CO₂ selectivity of at least 60% in the fixed bed reactor under the conditions thereof.

20. A method for performing dilute hydrocarbon oxidation (DHO) to convert hydrocarbons into carbon dioxide (CO₂), comprising:
mixing a first gas stream comprising hydrocarbons with a second gas stream comprising oxygen to form a third gas stream comprising hydrocarbons and oxygen, wherein the third gas stream contains less than 5 mol % hydrocarbons, and furthermore comprises oxygen in an amount at least stoichiometrically sufficient to completely oxidize the hydrocarbons to CO₂; and
performing a DHO reaction by contacting the third gas stream with a DHO catalytic material in a fixed bed reactor to produce a fourth gas stream comprising CO₂ in an amount greater than that present in the third gas stream, wherein the third gas stream enters the fixed bed reactor at a pressure no greater than 5 barg and at a temperature no greater than 600° C.,
wherein the DHO catalytic material comprises a mixed lanthanide oxide and one or more dopants,
wherein the mixed lanthanide oxide comprises a plurality of nanowires, and
wherein the DHO reaction using the DHO catalytic material as a heterogeneous catalyst has a hydrocarbon conversion of at least 60% and a CO₂ selectivity of at least 60% in the fixed bed reactor under the conditions thereof.
